(19) United States
(12) Patent Application Publication
(10) Pub. No.: US 2013/0012403 A1
(43) Pub. Date: Jan. 10, 2013

(54) Compositions and Methods for Identifying Autism Spectrum Disorders

(75) Inventor: Valerie Wailin Hu, Rockville, MD (US)

(73) Assignee: George Washington University, Washington, DC (US)

(21) Appl. No.: 13/518,456

(22) PCT Filed: Dec. 23, 2010
(86) PCT No.: PCT/US10/62064

§ 371 Date: Sep. 27, 2012

Related U.S. Application Data
(60) Provisional application No. 61/289,623, filed on Dec. 23, 2009.

(51) Int. Cl. C40B 30/04; C40B 40/06

(52) U.S. Cl. 506/9; 506/16

(57) ABSTRACT

The compositions and methods described are directed to microRNA chips having a plurality of different oligonucleotides with specificity for genes associated with autism spectrum disorders. The invention further provides methods of identifying microRNA profiles for neurological and psychiatric conditions including autism spectrum disorders, methods of treating such conditions, and methods of identifying therapeutics for the treatment of such neurological and psychiatric conditions.

### CROSS REFERENCE TO RELATED APPLICATION

This patent application claims priority to the Provisional Patent Application No. 61/289,623 filed on Dec. 23, 2009, the entire contents of which is incorporated herein by reference.

### FIELD OF THE INVENTION

This invention relates to microRNA (miRNA) microarray technology, and more specifically to methods and kits for identifying autism and autism spectrum disorders in humans.

### BACKGROUND OF THE INVENTION

Autism spectrum disorders (ASD) are developmental disabilities resulting from dysfunction in the central nervous system and are characterized by impairments in three behavioral areas: communication (notably spoken language), social interactions, and repetitive behaviors or restricted interests (Volkmar F R, et al (1994)). ASD usually manifest before three years of age and the severity can vary greatly. Idiopathic ASD include autism, which is considered to be the most severe form, pervasive developmental disorders not otherwise specified (PDD-NOS), and Asperger's syndrome, a milder form of autism in which persons can have relatively normal intelligence and communication skills but difficulty with social interactions. ASD with defined genetic etiologies or chromosomal aberration include Rett's syndrome, tuberous sclerosis, Fragile X syndrome, and chromosome 15 duplication (reviewed in (Muhle R, Trentacoste S V & Rapin I (2004))). Familial studies provide evidence that individuals closely related to an autistic individual (i.e. mother, father, and siblings) may have “autistic tendencies” but do not meet criterion for ASD, suggesting that a broad autism phenotype (BAP) may also exist (Piven J, Palmer P, Jacobi D, Childress D & Arndt S (1997)).

Previous studies establish a strong genetic component for the etiology of autism, and many loci have been proposed as autism susceptibility regions, including loci on chromosomes 1, 2, 7, 11, 13, 15, 16, 17 (reviewed in (Polleux F & Lauder J M (2004), Yonan A L, et al (2003), Santangelo S L & Tsatsanis K (2005), and Gupta A R & State M W (2007)). However, the specific genes involved within each locus have not been determined to date. Available data further suggests that multiple gene interactions, epigenetic factors, and environmental risk factors may also be at the core of autism etiology (Lathe R (2006)).

To examine global transcriptional changes associated with ASD, Hu et al. (2006) examined differential gene expression with DNA microarrays using lymphoblastoid cell lines from discordant monozygotic twins, one of which is diagnosed with autism whereas the other is not, and found that a number of genes important to nervous system development and functions are among the most differentially expressed genes. Furthermore, these genes could be placed in a relational gene network centered on inflammatory mediators (Hu et al. (2006)), some of which, (e.g., IL6) were observed to be increased in the autopsy brain tissues of autistic patients relative to non-autistic controls (Vargas et al. (2005)). Inasmuch as monozygotic twins share the same genotype, the results of this study further suggested a role for epigenetic factors in ASD.

MicroRNAs are endogenous single-stranded non-coding RNA molecules of approximately 22 nucleotides in length which negatively and post-transcriptionally regulate gene expression. The biogenesis and suppressive mechanisms of miRNAs have been comprehensively described in many studies and include both miRNA-mediated translational repression which may also ultimately lead to degradation of the transcript (Ambrose (2004); Bartel (2004); Cullen (2004); Kim (2005)). mRNAs are involved in nervous system development and function. Giraldez et al. (2005) demonstrated that zebrafish with a deficiency in mature miRNAs due to the lack of Dicer, an endoribonuclease protein playing an important role in processing pre-miRNA into mature miRNA duplex, exhibited specific developmental defects, including abnormal brain morphogenesis as a consequence of abnormal neuronal differentiation. In addition, disruptions of miRNA functions have been proposed to be associated with a number of neurological diseases, such as fragile X mental retardation (Caudy et al. (2002); Ishizuka et al. (2002); Jin et al. (2004)) and schizophrenia (Burmistrova et al. (2007)).

Thus, there is a need for systems and methods that will provide an increased understanding of the pathophysiology of Autism spectrum disorders, such as autism, pervasive developmental disorders not otherwise specified (PDD-NOS), and Asperger's syndrome, and their treatment.

The present invention satisfied these and other needs by demonstrating herein that one of the post-transcriptional regulatory mechanisms responsible for altered gene expression in ASD is altered expression of miRNA. The present invention provides compositions and methods for miRNA expression profiling and reveals significantly differentially expressed miRNAs whose putative target genes are associated with neurological diseases, nervous system development and function, as well as other co-morbid disorders associated with ASD, such as gastrointestinal, muscular, and inflammatory disorders.

### SUMMARY OF THE INVENTION

The invention provides genomic arrays and tools for the diagnosis, assessment and treatment of neurological and behavior disorders, such as autism spectrum disorder. The invention identifies a genes and expression products, including RNAs, that are associated with one or more autism-related disorders. A combination of the expression products provided herein is diagnostic for a number of neurological conditions and is also useful in assessing therapeutic choice and efficacy. Use of one or more arrays of expression products as described herein allows differential diagnosis of autism spectrum disorder and related conditions; as well as setting course of treamtment.

One aspect of the invention provides a gene chip or microRNA chip array having a plurality of different oligonucleotides with specificity for microRNAs associated with at least one autism spectrum disorder, wherein the autism spectrum disorder comprises autistic disorder, pervasive developmental disorder-not otherwise specified (PDD-NOS), including atypical autism, Asperger's Disorder, or a combination thereof.

In one embodiment of the present invention, a gene chip or microRNA chip array is provided wherein the oligonucleotides are specific for the microRNAs set out in Table 1, Table 2, or a combination thereof.

In another aspect of the invention, a method is provided for screening a subject for a neurological disease or disorder comprising the steps of: (a) isolating a nucleic acid, protein or cellular extract from at least one cell from the subject; (b) measuring the gene or microRNA expression level of at least five different microRNAs in Table 1, Table 2, or a combination thereof in the sample, wherein the at least five different microRNAs have been determined to have differential expression in subjects with a neurological disease or disorder, wherein the subject is diagnosed to be at risk for or affected by a neurological disease or disorder if there is a statistically significant difference in the gene or microRNA expression level in the at least five different microRNAs in the sample compared to the gene or microRNA expression level of the same microRNAs from a healthy individual.

In one embodiment of the screening method of the present invention, the neurological disease comprises at least one autism spectrum disorder, autistic disorder, pervasive developmental disorder-not otherwise specified (PDD-NOS) including atypical autism, Asperger's Disorder, or a combination thereof.

In another embodiment of the screening method of the present invention, the at least 5 different microRNAs in Table 1, Table 2, or a combination thereof comprise microRNAs involved in nervous system development, axon guidance, synaptic transmission or plasticity, myelination, long-term potentiation, neuron toxicity, embryonic development, regulation of actin networks, digestion, liver toxicity (hepatic stellate cell activation, fibrosis, and cholestasis), inflammation, oxidative stress, epilepsy, apoptosis, cell survival, differentiation, the unfolded protein response, Type II diabetes and insulin signaling, endocrine function, circadian rhythm, cholesterol metabolism and the steroidogenesis pathway, or a combination thereof.

In yet another embodiment of the screening method of the present invention, the healthy individual is a non-phenotypic discordant twin, sibling of the subject, or healthy, unrelated individual.

In yet another embodiment of the screening method of the present invention, the method distinguishes between different variants of autism spectrum disorder comprising a lower severity scores across all ADIR items, an intermediate severity across all ADIR items, a higher severity scores on spoken language items on the ADIR, a higher frequency of savant skills, and a severe language impairment, or a combination thereof.

In yet another embodiment of the screening method of the present invention, the miRNA expression is quantified with an assay comprising large scale microarray analysis, RT qPCR analysis, quantitative nuclease protection assay (qNPA) analysis, and focused gene chip analysis, in vitro transcription, Northern hybridization, nucleic acid hybridization, reverse transcription-polymerase chain reaction (RT-PCR), run-on transcription, Southern hybridization, electrophoretic mobility shift assay (EMSA), fluorescent or histochemical staining, microscopy and digital image analysis, and fluorescence activated cell analysis or sorting (FACS), nucleic acid hybridization, or a combination thereof.

In yet another aspect of the invention, a method is provided for determining a gene or microRNA profile for at least one autism spectrum disorder, comprising (a) preparing samples of control and experimental miRNA, wherein the experimental miRNA is generated from a nucleic acid sample isolated from a subject suspected of being afflicted with the at least one autism spectrum disorder and the control miRNA is generated from a nucleic acid sample isolated from a healthy individual; (b) preparing one or more microarrays comprising a plurality of different oligonucleotides having specificity for microRNAs associated with the at least one autism spectrum disorder; (c) applying the prepared samples to the one or more microarrays to allow hybridization between the oligonucleotides and the control miRNA and the oligonucleotide and the experimental miRNAs; (d) identifying the oligonucleotides on the microarray which display differential hybridization to the experimental miRNA relative to the control miRNA thereby determining a gene profile for the at least one autism spectrum disorder.

In one embodiment of the gene profiling method of the present invention, the plurality of different oligonucleotides is specific for at least five different microRNAs set out in Table 1, Table 2, or a combination thereof.

In another embodiment of the gene or microRNA profiling method of the present invention, the at least one autism spectrum disorder comprises autistic disorder, pervasive developmental disorder-not otherwise specified (PDD-NOS), including atypical autism, Asperger's Disorder, or a combination thereof.

In yet another aspect of the invention, a method is provided for distinguishing between different phenotypes of an autism spectrum disorder comprising severely language impaired (L), mildly affected (M), or “savants” (S) comprising (a) preparing samples of control and experimental miRNA, wherein the experimental miRNA is generated from a nucleic acid sample isolated from a subject suspected of being afflicted with at least one phenotype comprising the severely language impaired (L), mildly affected (M), or “savants” (S); (b) preparing one or more microarrays comprising a plurality of different oligonucleotides having specificity for microRNAs associated with the at least one phenotype; (c) applying the prepared samples to the one or more microarrays to allow hybridization between the oligonucleotides and the control and experimental miRNAs; (d) identifying the oligonucleotides on the microarray which display differential hybridization to the experimental miRNA relative to the control miRNA thereby determining a gene or microRNA profile for distinguishing among the different phenotypes of autism spectrum disorder.

In another embodiment of the phenotype distinguishing method of the present invention, the plurality of different oligonucleotides is specific for at least five different microRNAs set out in Table 1, Table 2, or a combination thereof.

In yet another embodiment of the phenotype distinguishing method of the present invention, the at least one autism spectrum disorder comprises autistic disorder, pervasive developmental disorder-not otherwise specified (PDD-NOS), including atypical autism, Asperger's Disorder, or a combination thereof.

In yet another aspect of the invention, a method is provided for predicting efficacy of a test compound for altering a behavioral response in a subject with at least one autism spectrum disorder comprising: (a) preparing a microarray comprising a plurality of different oligonucleotides, wherein the oligonucleotides are specific to microRNAs associated with an autism spectrum disorder; (b) obtaining a microRNA profile representative of the microRNA expression profile of at least one sample of a selected tissue type from a subject subjected to each of at least one of a plurality of selected behavioral therapies which promote the behavioral response; (c) administering the test compound to the subject; and (d) comparing microRNA expression profile data in at least one sample of the selected tissue type from the subject treated with the test compound to determine a degree of similarity with one or more microRNA profiles associated with an autism spectrum disorder; wherein the predicted efficacy of the test compound for altering the behavioral response is correlated to said degree of similarity.

In another embodiment of the compound efficacy testing method of the present invention, the plurality of oligonucleotides is specific for at least five different microRNAs set out in Table 1, Table 2, or a combination thereof.

In yet another embodiment of the compound efficacy testing method of the present invention, the autism spectrum disorder neurological condition comprises autistic disorder, pervasive developmental disorder-not otherwise specified (PDD-NOS), including atypical autism, Asperger's Disorder, or a combination thereof.

In yet another embodiment of the compound efficacy testing method of the present invention, step (a) comprises obtaining a microRNA profile representative of the microRNA expression profile of at least two samples of a selected tissue type.

In yet another embodiment of the compound efficacy testing method of the present invention, the selected tissue type comprises a neuronal tissue type.

In yet another embodiment of the compound efficacy testing method of the present invention, the neuronal tissue type is selected from the group consisting of olfactory bulb cells, cerebrospinal fluid, hypothalamus, amygdala, pituitary, nervous system, brainstem, cerebellum, cortex, frontal cortex, hippocampus, striatum, and thalamus.

In yet another embodiment of the compound efficacy testing method of the present invention, the selected tissue type is selected from the group consisting of lymphocytes, blood, or mucosal epithelial cells, brain, spinal cord, heart, arteries, esophagus, stomach, small intestine, large intestine, liver, pancreas, lungs, kidney, urinary tract, ovaries, breasts, uterus, testis, penis, colon, prostate, bone, muscle, cartilage, thyroid gland, adrenal gland, pituitary, bone marrow, blood, thymus, spleen, lymph nodes, skin, eye, ear, nose, teeth or tongue.

In yet another embodiment of the compound efficacy testing method of the present invention, the test compound is an antibody, a nucleic acid molecule, a small molecule drug, or a nutritional or herbal supplement.

In yet another embodiment of the compound efficacy testing method of the present invention, the behavioral therapy comprises applied behavior analysis (ABA) intervention methods, dietary changes, exercise, massage therapy, group therapy, talk therapy, play therapy, conditioning, or alternative therapies such as sensory integration and auditory integration therapies.

In yet another aspect of the invention a method is provided for assessing the efficacy of a treatment in an individual having at least one autism spectrum disorder comprising (a) determining differential microRNA expression profile data specific for at least five difference microRNAs set out in Table 1, Table 2, or a combination thereof, in a plurality of patient samples of a selected tissue type; (b) determining a degree of similarity between (a) the differential microRNA expression profile data in the patient samples; and (b) a differential microRNA profile specific for the microRNAs set out in listed in Table 1, Table 2, or a combination thereof, produced by a therapy which has been shown to be efficacious in treatment of the at least one autism spectrum disorder; wherein a high degree of similarity of the differential microRNA expression profile data is indicative that the treatment is effective.

In yet another aspect of the invention, a method is provided for determining a microRNA profile indicative of administration of a therapeutic treatment to a subject with at least one autism spectrum disorder comprising (a) preparing samples of control and experimental miRNA, wherein the experimental miRNA is generated from a nucleic acid sample isolated from a subject who has received the therapeutic treatment; (b) preparing one or more microarrays comprising a plurality of different oligonucleotides, wherein the oligonucleotides are specific to microRNAs associated with an autism spectrum disorder; (c) applying the prepared samples to the one or more microarrays to allow hybridization between the oligonucleotides and the control and experimental miRNAs; (d) identifying the oligonucleotides on the microarray which display differential hybridization to the experimental miRNA relative to the control miRNA thereby determining a microRNA profile indicative for the administration of the therapeutic treatment to the subject with at least one autism spectrum disorder.

In another embodiment of the method of the present invention, the plurality of different oligonucleotides is specific for at least five different microRNAs set out in Table 1, Table 2, or a combination thereof.

In yet another embodiment of the method of the present invention, the at least one autism spectrum disorder neurological condition comprises autistic disorder, pervasive developmental disorder-not otherwise specified (PDD-NOS), including atypical autism, Asperger's Disorder, or a combination thereof.

In yet another aspect of the invention, a method is provided for conducting drug discovery comprising (a) generating a database of microRNA profile data representative of the genetic expression response of at least one selected neuronal tissue type from a subject that was subjected to at least one of a plurality of behavioral therapies and that has undergone a selected physiological change since commencement of the behavioral therapy; (b) administering small molecule test agents to untreated subjects to obtain microRNA expression profile data associated with administration of the agents and comparing the obtained data with the one or more selected microRNA profiles; (c) selecting test agents that induce microRNA profiles similar to microRNA profiles obtainable by administration of behavioral therapy; (d) conducting therapeutic profiling of the selected test compound(s), or analogs thereof, for efficacy and toxicity in subjects; and (e) identifying a pharmaceutical preparation including one or more agents identified in step (d) as having an acceptable therapeutic and/or toxicity profile.

In another embodiment of the method of the present invention, the behavioral therapy comprises applied behavior analysis (ABA) intervention methods, dietary changes, exercise, massage therapy, group therapy, talk therapy, play therapy, conditioning, or alternative therapies such as sensory integration and auditory integration therapies.

In yet another embodiment of the method of the present invention, the selected physiological change includes one or more improvements in social interaction, language abilities, restricted interests, repetitive behaviors, sleep disorders, seizures, gastrointestinal, hepatic, and mitochondrial function, neural inflammation, or a combination thereof.

In yet another embodiment of the method of the present invention, prior to administration of behavioral therapy, the subject shows at least one symptom of a psychological or physiological abnormality.

In yet another embodiment of the method of the present invention, the neuronal tissue type is selected from the group consisting of olfactory bulb cells, cerebrospinal fluid, hypothalamus, amygdala, pituitary, nervous system, brainstem, cerebellum, cortex, frontal cortex, hippocampus, striatum, and thalamus.

In yet another aspect of the invention, a kit is provided for identifying a compound for treating at least one autism spectrum disorder comprising (a) a database having information stored therein one or more differential microRNA expression profiles specific for the microRNAs set out in listed in Table 1, Table 2, or a combination thereof, of subjects that have been subjected to at least one of a plurality of selected autism spectrum disorder neurological therapies and wherein the subject has undergone a desired physiological change; and (b) a computer program for comparing microRNA expression profile data obtained from assays wherein a test compound is administered to a subject with the database and providing information representative of a measure of similarity between the microRNA expression profile data and one or more stored microRNA profiles.

In yet another aspect of the invention, a computer-implemented method is provided for determining a microRNA profile for at least one autism spectrum disorder wherein the method comprises the steps of: (a) generating a database of microRNA profile data representative of the differential microRNA expression profiles specific for microRNAs that have been determined to have increased or decreased expression in subjects with an autism spectrum disorder into a form suitable for computer-based analysis; and (b) analyzing the compiled data, wherein the analyzing comprises identifying microRNA networks from a number of upregulated pathway microRNAs and/or downregulated pathway microRNAs, wherein the pathway microRNAs include those microRNAs that have been identified as associating with severity of autism or an autism spectrum disorder, wherein said microRNAs comprise at least five different microRNAs set out in listed in Table 1, Table 2, or a combination thereof.

In yet another aspect of the invention, a computer-readable medium is provided on which is encoded programming code for analyzing autism spectrum disorder differential microRNA expression from a plurality of data points comprising a microRNA expression profile of differentially expressed microRNAs, wherein said differential microRNA expression profile is specific for at least five different microRNAs set out in Table 1, Table 2, or a combination thereof.

In yet another aspect of the invention, each of the microRNA chip compositions and methods of use thereof, kits and computer readable mediums specifically provided for supra (and infra) may also be, without any limitation, made and/or practiced with at least one, two, three, four, or five or more of any of the microRNAs described in any one or more of Tables 1-2 as shown infra.

In yet another embodiment of the invention, in each of the screening methods, microRNA profiling methods, phenotype distinguishing methods, drug discovery methods, compound efficacy testing methods, computer-implemented methods for determining a microRNA profile, and kits described supra, the differential microRNA expression profile is specific for at least twenty different microRNAs set out in Table 1, Table 2, or a combination thereof.

### BRIEF DESCRIPTION OF THE DRAWINGS

The foregoing and other aspects and advantages of the invention will be appreciated more fully from the following further description thereof, with reference to the accompanying drawings wherein:

FIG. 1 Hierarchical Cluster Analysis (HCL) and Principal Component Analysis (PCA) of Significantly Differentially Expressed miRNAs from the PTM-SAM Analyses. A) Unsupervised HCL of 48 significantly differentially expressed miRNAs from a two-class PTM-SAM analysis between all autistic individuals (red bar) and controls (turquoise bar) shows the distinct miRNA expression pattern of the two groups (p<0.05 and FDR<0.001%). B) PCA of the samples based on the same set of miRNAs reduces the dimensionality of the data and shows the clear separation between the autistic individuals (red) and the controls (turquoise).

FIG. 2 Results of TaqMan miRNA qRT-PCR. Expression levels of selected miRNAs associated with brain development from TaqMan RT-PCR analyses confirm data obtained by miRNA microarrays.

FIG. 3 Relationships between Differentially Expressed miRNAs, Putative Target Genes, and Functions. Network and pathway analysis using Pathway Studio 5 shows the relationships among the significantly differentially expressed miRNAs, potential target genes (expression cutoff log₂ ratio≧±0.4), and biological functions and disorders implicated by the differentially expressed target genes. Up-regulated genes and miRNAs are in red; down-regulated genes and miRNAs are in green.

FIG. 4 Validation of miRNA Targets. Three LCLs from non-autistic individuals were transfected with hsa-miR-29b Pre-miR Precursor or hsa-miR-219b Anti-miR Inhibitor. At 72 hours after transfection, qRT-PCR analyses were conducted to determine expression of PLK2 and ID3 genes in the Anti-miR/Pre-miR-transfected LCLs (Red), compared to respective negative controls (Navy). Expression of PLK2 was significantly increased in the LCLs transfected with Anti-miR-2,9-5p (A), whereas ID3 expression was significantly decreased in Pre-miR-29b-transfected LCLs (B). (*p<0.05)

### DETAILED DESCRIPTION OF THE INVENTION

The invention disclosed herein provides methods and compositions for diagnosis and treatment of neurological conditions. In particular, the invention provides genomic arrays for diagnosing and treating autism spectrum disorders. The invention relates, in part, to sets of genetic markers whose expression patterns are associated with neurological conditions, such as autism spectrum disorder.

Aspects of the invention are useful for identifying expression patterns that are informative for diagnosis, prognosis, and/or treatment of neurological conditions. The invention also provides not only methods of identifying microRNA profiles for neurological conditions, but alsoprovides methods of using such microRNA profiles for therapeutic selection. The invention further relates to the application of microRNA profiles for the identification of therapeutic targets.

In one aspect, the invention provides microarray systems, including microRNA chips and arrays of nucleotide sequences for detecting microRNA, for diagnosis of neurological conditions, such as autism spectrum disorder conditions. MicroRNA systems and methods described herein comprise a plurality of oligonucleotide primers having specificity for microRNA associated with a neurological condition. on a surface.

To provide an overall understanding of the invention, certain illustrative embodiments will now be described. However, it will be understood by one of ordinary skill in the art that the systems and methods described herein can be adapted and modified for other suitable applications and that such other additions and modifications will not depart from the scope hereof.

### DEFINITIONS

For convenience, certain terms employed in the specification, examples, and appended claims, are collected here. Unless defined otherwise, all technical and scientific terms used herein have the same meaning as commonly understood by one of ordinary skill in the art to which this invention belongs.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited to”.

The term “or” is used herein to mean, and is used interchangeably with, the term “and/or,” unless context clearly indicates otherwise.

The term “such as” is used herein to mean, and is used interchangeably, with the phrase “such as but not limited to”.

A “patient” or “subject” to be treated by the method of the invention can mean either a human or non-human animal, preferably a mammal.

The term “encoding” comprises an RNA product resulting from transcription of a DNA molecule, a protein resulting from the translation of an RNA molecule, or a protein resulting from the transcription of a DNA molecule and the subsequent translation of the RNA product.

The term “expression” is used herein to mean the process by which a polypeptide is produced from DNA. The process involves the transcription of the gene into mRNA and the translation of this mRNA into a polypeptide. Depending on the context in which used, “expression” may refer to the production of RNA, protein or both.

The term “transcriptional regulator” refers to a biochemical element that acts to prevent or inhibit the transcription of a promoter-driven DNA sequence under certain environmental conditions (e.g., a repressor or nuclear inhibitory protein), or to permit or stimulate the transcription of the promoter-driven DNA sequence under certain environmental conditions (e.g., an inducer or an enhancer).

The terms “microarray,” “microRNA chip,” “GeneChip,” “genome chip,” and “biochip,” as used herein refer to an ordered arrangement of hybridizeable array elements. The array elements are arranged so that there are preferably at least one or more different array elements on a substrate surface, such as paper, nylon or other type of membrane, filter, chip, glass slide, or any other suitable solid support. The hybridization signal from each of the array elements is individually distinguishable.

The terms “complementary” or “complementarity” as used herein refer to polynucleotides (i.e., a sequence of nucleotides) related by the base-pairing rules. For example, for the sequence “A-G-T,” is complementary to the sequence “T-C-A.” Complementarity may be “partial,” in which only some of the nucleic acids' bases are matched according to the base pairing rules. Or, there may be “complete” or “total” complementarity between the nucleic acids. The degree of complementarity between nucleic acid strands has significant effects on the efficiency and strength of hybridization between nucleic acid strands. This is of particular importance in amplification reactions, as well as detection methods which depend upon binding between nucleic acids.

As used herein, the term “hybridization” is used in reference to the pairing of complementary nucleic acids. Hybridization and the strength of hybridization (i.e., the strength of the association between the nucleic acids) is impacted by such factors as the degree of complementary between the nucleic acids, stringency of the conditions involved, the Tₘ of the formed hybrid, and the G:C ratio within the nucleic acids.

As used herein, the term “primer” refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, (i.e., in the presence of nucleotides and an inducing agent such as DNA polymerase and at a suitable temperature and pH). The primer is preferably single stranded for maximum efficiency in amplification, but may alternatively be double stranded. If double stranded, the primer is first treated to separate its strands before being used to prepare extension products. Preferably, the primer is an oligodeoxy ribonucleotide. The primer must be sufficiently long to prime the synthesis of extension products in the presence of the inducing agent. The exact lengths of the primers will depend on many factors, including temperature, source of primer and the use of the method.

As used herein, the term “probe” refers to an oligonucleotide (i.e., a sequence of nucleotides), whether occurring naturally as in a purified restriction digest or produced synthetically, recombinantly or by PCR amplification, which is capable of hybridizing to another oligonucleotide of interest. A probe may be single-stranded or double-stranded. Probes are useful in the detection, identification and isolation of particular microRNA sequences. It is contemplated that any probe used in the present invention will be labeled with any “reporter molecule,” so that is detectable in any detection system, including, but not limited to enzyme (e.g., ELISA, as well as enzyme-based histochemical assays), fluorescent, radioactive, and luminescent systems. It is not intended that the present invention be limited to any particular detection system or label.

As used herein, the terms “compound” and “test compound” refer to any chemical entity, pharmaceutical, drug, and the like that can be used to treat or prevent a disease, illness, conditions, or disorder of bodily function. Compounds comprise both known and potential therapeutic compounds. A compound can be determined to be therapeutic by screening using the screening methods of the present invention. A “known therapeutic compound” refers to a therapeutic compound that has been shown (e.g., through animal trials or prior experience with administration to humans) to be effective in such treatment. In other words, a known therapeutic compound is not limited to a compound efficacious in the treatment of cancer. Examples of test compounds include, but are not limited to peptides, polypeptides, synthetic organic molecules, naturally occurring organic molecules, nucleic acid molecules, and combinations thereof.

A “sample” from a subject may include a single cell or multiple cells or fragments of cells or an aliquot of body fluid, taken from the subject, by means including venipuncture, excretion, ejaculation, massage, biopsy, needle aspirate, lavage sample, scraping, surgical incision or intervention or other means known in the art.

As used herein, the term “subject” refers to a cell, tissue, or organism, human or non-human, whether in vivo, ex vivo or in vitro, under observation.

As used herein, the term “increased expression” refers to the level of a gene expression product that is made higher and/or the activity of the gene expression product that is enhanced. Preferably, the increase is by at least 1.22-fold, 1.5-fold, more preferably the increase is at least 2-fold, 5-fold, or 10-fold, and most preferably, the increase is at least 20-fold, relative to a control.

As used herein, the term “decreased expression” refers to the level of a gene expression product that is made lower and/or the activity of the gene expression product that is lowered. Preferably, the decrease is at least 25%, more preferably, the decrease is at least 50%, 60%, 70%, 80%, or 90% and most preferably, the decrease is at least one-fold, relative to a control.

As used herein, the term “gene profile” or “microRNA profile” refers to an experimentally verified subset of values associated with the expression level of a set of gene products from informative genes which allows the identification of a biological condition, an agent and/or its biological mechanism of action, or a physiological process.

As used herein, the term “microRNA expression profile,” or “gene expression profile” refers to the level or amount of gene expression of particular genes, for example, informative genes, as assessed by methods described herein. The microRNA expression profile or gene expression profile can comprise data for one or more informative genes and can be measured at a single time point or over a period of time. For example, the microRNA expression profile or gene expression profile can be determined using a single informative gene, or it can be determined using two or more informative genes, three or more informative genes, five or more informative genes, ten or more informative genes, twenty-five or more informative genes, or fifty or more informative genes. A microRNA expression profile or gene expression profile may include expression levels of genes that are not informative, as well as informative genes. Phenotype classification (e.g., the presence or absence of a neurological disorder) can be made by comparing the microRNA expression profile or gene expression profile of the sample with respect to one or more informative genes with one or more microRNA expression profile or gene expression profiles (e.g., in a database). Using the methods described herein, expression of numerous genes can be measured simultaneously. The assessment of numerous genes provides for a more accurate evaluation of the sample because there are more genes that can assist in classifying the sample. A microRNA expression profile or gene expression profile may involve only those genes that are increased in expression in a sample, only those genes that are decreased in expression in a sample, or a combination of genes that are increased and decreased in expression in a sample.

The terms “disorders” and “diseases” are used inclusively and refer to any deviation from the normal structure or function of any part, organ or system of the body (or any combination thereof). A specific disease is manifested by characteristic symptoms and signs, including biological, chemical and physical changes, and is often associated with a variety of other factors including, but not limited to, demographic, environmental, employment, genetic and medically historical factors. Certain characteristic signs, symptoms, and related factors can be quantitated through a variety of methods to yield important diagnostic information.

The term “neurological condition” or “neurological disorder” is used herein to mean mental, emotional, or behavioral abnormalities. These include but are not limited to autism spectrum disorder conditions including autism, asperger's disorder, bipolar disorder I or II, schizophrenia, schizoaffective disorder, psychosis, depression, stimulant abuse, alcoholism, panic disorder, generalized anxiety disorder, attention deficit disorder, post-traumatic stress disorder, Parkinson's disease, or a combination thereof.

### Gene Chips

One aspect of the invention provides gene or microRNA chips. Gene or microRNA chips, also called “biochips” or “arrays” or “microarrays” are miniaturized devices typically with dimensions in the micrometer to millimeter range for performing chemical and biochemical reactions and are particularly suited for embodiments of the invention. Arrays may be constructed via microelectronic and/or microfabrication using essentially any and all techniques known and available in the semiconductor industry and/or in the biochemistry industry, provided that such techniques are amenable to and compatible with the deposition and screening of polynucleotide sequences. Microarrays are particularly desirable for their virtues of high sample throughput and low cost for generating profiles and other data.

One specific aspect of the invention provides a gene chip or microRNA chip having a plurality of different oligonucleotides having specificity for genes associated with neurological conditions, and in particular, autism spectrum disorder conditions including pervasive developmental disorder-not otherwise specified (PDD-NOS), including atypical autism, Asperger's Disorder, or a combination thereof. In a related embodiment, the invention provides a gene chip or microRNA chip having a plurality of different oligonucleotides having specificity for genes whose expression level changes in a subject who is afflicted with neurological conditions, and in particular, autism spectrum disorder conditions including pervasive developmental disorder-not otherwise specified (PDD-NOS), including atypical autism, Asperger's Disorder, or a combination thereof when the subject responds favorably to a therapeutic treatment that is intended to treat the neurological condition.

In one embodiment of the gene chips provided herein, the oligonucleotides on the gene chip or microRNA chip comprise oligonucleotides that are specific for the genes set out in Tables 1, 2, or combinations thereof. In another embodiment, the gene chip or microRNA chip has oligonucleotides specific for the genes associated with autism spectrum disorder conditions including pervasive developmental disorder-not otherwise specified (PDD-NOS), including atypical autism, Asperger's Disorder, or a combination thereof.

In another specific embodiment, the gene chip or microRNA chip has at least one oligonucleotide specific for genes associated with the cellular response to androgens. In another specific embodiment, the gene chip or microRNA chip has at least one oligonucleotide specific for genes associated with the cellular response to androgens.

In another specific embodiment, the gene chip or microRNA chip has at least one oligonucleotide specific for genes associated with circadian rhythm. In another specific embodiment, the gene chip or microRNA chip has at least one oligonucleotide specific for the circadian rhythm associated genes, or any of the genes set out in Table 3, or any combination thereof.

In another specific embodiment, the gene chip or microRNA chip has at least one oligonucleotide specific for target genes associated with WNT signaling, axon guidance, regulation of the cytoskeleton, Type II Diabetes Mellitus, insulin signaling pathways, cholesterol metabolism, and steroid hormone biosynthesis pathways, nervous system development, synaptic transmission or plasticity, myelination, long-term potentiation, neuron toxicity, embryonic development, regulation of actin networks, digestion, liver toxicity (hepatic stellate cell activation, fibrosis, and cholestasis), inflammation, oxidative stress, epilepsy, apoptosis, cell survival, differentiation, the unfolded protein response, endocrine function, circadian rhythm, cholesterol metabolism or a combination thereof.

In another embodiment, the gene chip or microRNA chip comprises oligonucleotide probes specific for genes associated with apoptosis and inflammation, as well as many neurological and metabolic processes commonly associated with ASD, such as myelination, neuron plasticity, synaptic transmission, and hypercholesterolemia. In one embodiment, the gene chip or microRNA chip comprises oligonucleotides specific for ITGAM, NFKB1, RHOA, SLIT2, MBD2, MECP2, or a combination thereof.

In another specific embodiment of the gene chips or microRNA chips provided herein, the gene chip or microRNA chip comprises at least 3, 5, 10, 15, 20 or 25 of the probes are derived from oligonucleotides that are specific for the microRNAs set out in any one of Tables 1, 2, or a combination thereof. In a related embodiment, at least 50% of the probes on the gene chip or microRNA chip are derived from oligonucleotides that are specific for the microRNAs present in any one of Tables 1, 2 or a combination thereof. In a related embodiment, at least 70%, 80%, 90%, 95% or 98% of the probes on the gene chip or microRNA chip are derived from oligonucleotides that are specific for the microRNAs present in any one of Tables 1, 2, or combinations thereof.

The invention further provides a gene chip for distinguishing cell samples from individuals having a positive prognosis and cell samples from individuals having a negative prognosis, wherein prognosis refers to the progression of disease or prognosis for successful treatment by a given treatment regimen or agent, comprising a positionally-addressable array of polynucleotide probes bound to a support, said polynucleotide probes comprising a plurality of polynucleotide probes of different nucleotide sequences, each of said different nucleotide sequences comprising a sequence complementary and hybridizable to a different, said plurality consisting of at least 5 of the microRNAs listed in Tables 1, 2, or a combination thereof.

In some embodiments of the gene chips, processes, methods and kits provided by the invention, the neurological condition is selected from the group consisting of autism spectrum disorders, autism, atypical autism, pervasive developmental disorder-not otherwise specified (PDD-NOS), asperger's disorder, Rett's syndrome, allodynia, catalepsy, hypernocieption, Parkinson's disease, parkinsonism, cognitive impairments, age-associated memory impairments, cognitive impairments, dementia associated with neurologic and/or neurological conditions, allodynia, catalepsy, hypernocieption, and epilepsy, brain tumors, brain lesions, multiple sclerosis, Down's syndrome, progressive supranuclear palsy, frontal lobe syndrome, schizophrenia, delirium, Tourette's syndrome, myasthenia gravis, attention deficit hyperactivity disorder, dyslexia, mania, depression, apathy, myopathy, Alzheimer's disease, Huntington's Disease, dementia, encephalopathy, schizophrenia, severe clinical depression, brain injury, Attention Deficit Disorder (ADD), Attention Deficit Hyperactivity Disorder (ADHD), hyperactivity disorder, Asperger's Disorder, bipolar manic-depressive disorder, ischemia, alcohol addiction, drug addiction, obsessive compulsive disorders, Pick's disease and Binswanger's disease.

DNA microarray and methods of analyzing data from microarrays are well-described in the art, including in DNA Microarrays: A Molecular Cloning Manual, Ed by Bowtel and Sambrook (Cold Spring Harbor Laboratory Press, 2002); Microarrays for an Integrative Genomics by Kohana (MIT Press, 2002); A Biologist's Guide to Analysis of DNA Microarray Data, by Knudsen (Wiley, John & Sons, Incorporated, 2002); and DNA Microarrays: A Practical Approach, Vol. 205 by Schema (Oxford University Press, 1999); and Methods of Microarray Data Analysis II, ed by Lin et al. (Kluwer Academic Publishers, 2002), hereby incorporated by reference in their entirety.

Microarrays may be prepared by selecting probes which comprise a polynucleotide sequence, and then immobilizing such probes to a solid support or surface. For example, the probes may comprise DNA sequences, RNA sequences, or copolymer sequences of DNA and RNA. The polynucleotide sequences of the probes may also comprise DNA and/or RNA analogues, or combinations thereof. For example, the polynucleotide sequences of the probes may be full or partial fragments of genomic DNA. The polynucleotide sequences of the probes may also be synthesized nucleotide sequences, such as synthetic oligonucleotide sequences. The probe sequences can be synthesized either enzymatically in vivo, enzymatically in vitro (e.g., by PCR), or non-enzymatically in vitro.

The probe or probes used in the methods and gene chips of the invention may be immobilized to a solid support which may be either porous or non-porous. For example, the probes of the invention may be polynucleotide sequences which are attached to a nitrocellulose or nylon membrane or filter covalently at either the 3′ or the 5′ end of the polynucleotide. Such hybridization probes are well known in the art (see, e.g., Sambrook et al., MOLECULAR CLONING—A LABORATORY MANUAL (2ND ED.), Vols. 1-3, Cold Spring Harbor Laboratory, Cold Spring Harbor, N.Y. (1989). Alternatively, the solid support or surface may be a glass or plastic surface. In a particularly preferred embodiment, hybridization levels are measured to microarrays of probes consisting of a solid phase on the surface of which are immobilized a population of polynucleotides, such as a population of DNA or DNA mimics, or, alternatively, a population of RNA or RNA mimics. The solid phase may be a nonporous or, optionally, a porous material such as a gel.

In one embodiment, a microarray comprises a support or surface with an ordered array of binding (e.g., hybridization) sites or “probes” each representing one of the markers described herein. Preferably the microarrays are addressable arrays, and more preferably positionally addressable arrays. More specifically, each probe of the array is preferably located at a known, predetermined position on the solid support such that the identity (i.e., the sequence) of each probe can be determined from its position in the array (i.e., on the support or surface). In preferred embodiments, each probe is covalently attached to the solid support at a single site.

Microarrays can be made in a number of ways, of which several are described below. However produced, microarrays share certain characteristics. The arrays are reproducible, allowing multiple copies of a given array to be produced and easily compared with each other. Preferably, microarrays are made from materials that are stable under binding (e.g., nucleic acid hybridization) conditions. The microarrays are preferably small, e.g., between 1 cm² and 25 cm², between 12 cm² and 13 cm², or about 3 cm². However, larger arrays are also contemplated and may be preferable, e.g., for use in screening arrays. Preferably, a given binding site or unique set of binding sites in the microarray will specifically bind (e.g., hybridize) to the product of a single gene in a cell (e.g., to a specific mRNA, or to a specific miRNA derived therefrom). However, in general, other related or similar sequences will cross hybridize to a given binding site.

The microarrays of the present invention include one or more test probes, each of which has a polynucleotide sequence that is complementary to a subsequence of RNA or DNA to be detected. Preferably, the position of each probe on the solid surface is known. Indeed, the microarrays are preferably positionally addressable arrays. Specifically, each probe of the array is preferably located at a known, predetermined position on the solid support such that the identity (i.e., the sequence) of each probe can be determined from its position on the array (i.e., on the support or surface).

According to one aspect of the invention, the microarray is an array (i.e., a matrix) in which each position represents one of the markers or gene biomarkers or microRNAs as described herein. For example, each position can contain a DNA or DNA analogue based on genomic DNA to which a particular RNA or miRNA transcribed from that genetic marker or biomarker can specifically hybridize. The DNA or DNA analogue can be, for example, a synthetic oligomer or a gene fragment. In one embodiment, probes representing each of the genes or biomarkers or microRNAs on Tables 1, 2, or a combination thereof are present on the array.

As noted above, the “probe” to which a particular polynucleotide molecule specifically hybridizes according to the invention contains a complementary polynucleotide sequence. In one embodiment, the probes of the microRNA array consist of nucleotide sequences of 10 to 1,000 nucleotides. In a preferred embodiment, the nucleotide sequences of the probes are in the range of 10-200 nucleotides in length and are genomic sequences of a species of organism, such that a plurality of different probes is present, with sequences complementary and thus capable of hybridizing to the genome of such a species of organism, sequentially tiled across all or a portion of such genome. In other specific embodiments, the probes are in the range of 10-30 nucleotides in length, in the range of 10-40 nucleotides in length, in the range of 20-50 nucleotides in length, in the range of 40-80 nucleotides in length, in the range of 50-150 nucleotides in length, in the range of 80-120 nucleotides in length, and most preferably are 60 nucleotides in length.

The probes may comprise DNA or DNA “mimics” (e.g., derivatives and analogues) corresponding to a portion of an organism's genome. In another embodiment, the probes of the microarray are complementary RNA or RNA mimics. DNA mimics are polymers composed of subunits capable of specific, Watson-Crick-like hybridization with DNA, or of specific hybridization with RNA. The nucleic acids can be modified at the base moiety, at the sugar moiety, or at the phosphate backbone. Exemplary DNA mimics include, e.g., phosphorothioates.

DNA can be obtained, e.g., by polymerase chain reaction (PCR) amplification of genomic DNA or cloned sequences. PCR primers are preferably chosen based on a known sequence of the genome that will result in amplification of specific fragments of genomic DNA. Computer programs that are well known in the art are useful in the design of primers with the required specificity and optimal amplification properties, such as Oligo version 5.0 (National Biosciences). Typically each probe on the microarray will be between 10 bases and 50,000 bases, usually between 300 bases and 1,000 bases in length. PCR methods are well known in the art, and are described, for example, in Innis et al., eds., PCR: Protocols: A Guide to Methods and Applications, Academic Press Inc., San Diego, Calif. (1990). It will be apparent to one skilled in the art that controlled robotic systems are useful for isolating and amplifying nucleic acids.

An alternative, preferred means for generating the polynucleotide probes of the microarray is by synthesis of synthetic polynucleotides or oligonucleotides, e.g., using N-phosphonate or phosphoramidite chemistries (Froehler et al., Nucleic Acid Res. 14:5399-5407 (1986); McBride et al., Tetrahedron Lett. 24:246-248 (1983)). Synthetic sequences are typically between about 10 and about 500 bases in length, more typically between about 20 and about 100 bases, and most preferably between about 40 and about 70 bases in length. In some embodiments, synthetic nucleic acids include non-natural bases, such as, but by no means limited to, inosine. As noted above, nucleic acid analogues may be used as binding sites for hybridization. An example of a suitable nucleic acid analogue is peptide nucleic acid (see, e.g., Egholm et al., Nature 363:566-568 (1993); U.S. Pat. No. 5,539,083). Probes are preferably selected using an algorithm that takes into account binding energies, base composition, sequence complexity, cross-hybridization binding energies, and secondary structure (see Friend et al., International Patent Publication WO 01/05935, published Jan. 25, 2001; Hughes et al., Nat. Biotech. 19:342-7 (2001)).

A skilled artisan will also appreciate that positive control probes, e.g., probes known to be complementary and hybridizable to sequences in the miRNA molecules, and negative control probes, e.g., probes known to not be complementary and hybridizable to sequences in the miRNA molecules, should be included on the array. In one embodiment, positive controls are synthesized along the perimeter of the array. In another embodiment, positive controls are synthesized in diagonal stripes across the array. In still another embodiment, the reverse complement for each probe is synthesized next to the position of the probe to serve as a negative control. In yet another embodiment, sequences from other species of organism are used as negative controls or as “spike-in” controls.

The probes may be attached to a solid support or surface, which may be made, e.g., from glass, plastic (e.g., polypropylene, nylon), polyacrylamide, nitrocellulose, gel, or other porous or nonporous material. A preferred method for attaching the nucleic acids to a surface is by printing on glass plates, as is described generally by Schena et al, Science 270:467-470 (1995). This method is especially useful for preparing microarrays of miRNA (See also, DeRisi et al, Nature Genetics 14:457-460 (1996); Shalon et al., Genome Res. 6:639-645 (1996); and Schena et al., Proc. Natl. Acad. Sci. U.S.A. 93:10539-11286 (1995)).

A second preferred method for making microarrays is by making high-density oligonucleotide arrays. Techniques are known for producing arrays containing thousands of oligonucleotides complementary to defined sequences, at defined locations on a surface using photolithographic techniques for synthesis in situ (see, Fodoret al., 1991, Science 251:767-773; Pease et al., 1994, Proc. Natl. Acad. Sci. U.S.A. 91:5022-5026; Lockhart et al., 1996, Nature Biotechnology 14:1675; U.S. Pat. Nos. 5,578,832; 5,556,752; and 5,510,270) or other methods for rapid synthesis and deposition of defined oligonucleotides (Blanchard et al., Biosensors & Bioelectronics 11:687-690). When these methods are used, oligonucleotides (e.g., 60-mers) of known sequence are synthesized directly on a surface such as a derivatized glass slide. Usually, the array produced is redundant, with several oligonucleotide molecules per RNA.

Other methods for making microarrays, e.g., by masking (Maskos and Southern, 1992, Nuc. Acids. Res. 20:1679-1684), may also be used. In principle, and as noted supra, any type of array, for example, dot blots on a nylon hybridization membrane (see Sambrook et al., MOLECULAR CLONING—A LABORATORY MANUAL (2ND ED.), Vols. 1-3, Cold Spring Harbor Laboratory, Cold Spring Harbor, N.Y. (1989)) could be used. However, as will be recognized by those skilled in the art, very small arrays will frequently be preferred because hybridization volumes will be smaller. In one embodiment, the arrays of the present invention are prepared by synthesizing polynucleotide probes on a support. In such an embodiment, polynucleotide probes are attached to the support covalently at either the 3′ or the 5′ end of the polynucleotide.

In a one embodiment, microarrays of the invention are manufactured by means of an ink jet printing device for oligonucleotide synthesis, e.g., using the methods and systems described by Blanchard in U.S. Pat. No. 6,028,189; Blanchard et al., 1996, Biosensors and Bioelectronics 11:687-690; Blanchard, 1998, in SYNTHETIC DNA ARRAYS IN GENETIC ENGINEERING, Vol. 20, J. K. Setlow, Ed., Plenum Press, New York at pages 111-123. Specifically, the oligonucleotide probes in such microarrays are preferably synthesized in arrays, e.g., on a glass slide, by serially depositing individual nucleotide bases in “microdroplets” of a high surface tension solvent such as propylene carbonate. The microdroplets have small volumes (e.g., 100 pL or less, more preferably 50 pL or less) and are separated from each other on the microarray (e.g., by hydrophobic domains) to form circular surface tension wells which define the locations of the array elements (i.e., the different probes). Microarrays manufactured by this ink-jet method are typically of high density, preferably having a density of at least about 2,500 different probes per 1 cm². The polynucleotide probes are attached to the support covalently at either the 3′ or the 5′ end of the polynucleotide.

Methods of Determining MicroRNA Profiles

One aspect of the invention provides methods for determining a microRNA profile for a specific neurological disorder or neurological condition, such as autism spectrum disorder conditions including autistic disorder, pervasive developmental disorder-not otherwise specified (PDD-NOS), including atypical autism, Asperger's Disorder. Furthermore, the systems and methods described herein may be employed to generate microRNA profiles for diseases or disorders of interest. This expression data may be analyzed independently to determine a microRNA profile of interest, or combined with the existing biological data stored in a plurality of different types of databases. Statistical analyses may be applied as well as machine learning techniques that are used to discover trends and patterns in the underlying data. These techniques include clustering methods, which can be used for example to organize microarray expression data.

One specific aspect of the invention provides a method for determining a gene profile or microRNA profile for a neurological condition, comprising (i) preparing samples of control and experimental miRNA, wherein the experimental miRNA is generated from a nucleic acid sample isolated from a subject suspected of being afflicted with the neurological condition; (ii) preparing one or more microarrays comprising a plurality of different oligonucleotides having specificity for genes associated with the neurological condition; (iii) applying the prepared samples to the one or more microarrays to allow hybridization between the oligonucleotides and the control and experimental miRNAs; (v) identifying the oligonucleotides on the microarray which display differential hybridization to the experimental miRNA relative to the control miRNA; and (vi) identifying a set of genes from the oligonucleotides identified in step (v) thereby determining a gene profile or microRNA profile for the neurological condition.

In a preferred embodiment, the neurological condition is an autism spectrum disorder condition including autistic disorder, pervasive developmental disorder-not otherwise specified (PDD-NOS), including atypical autism, Asperger's Disorder, or a combination thereof. In another embodiment, the neurological condition is selected from the group consisting of autism spectrum disorder conditions including autistic disorder, pervasive developmental disorder-not otherwise specified (PDD-NOS), including atypical autism, Asperger's Disorder, Rett's syndrome, Parkinson's disease, parkinsonism, cognitive impairments, age-associated memory impairments, cognitive impairments, dementia associated with neurologic and/or neurological conditions, allodynia, catalepsy, hypernocieption, and epilepsy, brain tumors, brain lesions, multiple sclerosis, Down's syndrome, progressive supranuclear palsy, frontal lobe syndrome, schizophrenia, delirium, Tourette's syndrome, myasthenia gravis, attention deficit hyperactivity disorder, dyslexia, mania, depression, apathy, myopathy, Alzheimer's disease, Huntington's Disease, dementia, encephalopathy, schizophrenia, severe clinical depression, brain injury, Attention Deficit Disorder (ADD), Attention Deficit Hyperactivity Disorder (ADHD), hyperactivity disorder, bipolar manic-depressive disorder, ischemia, alcohol addiction, drug addiction, obsessive compulsive disorders, Pick's disease and Binswanger's disease.

In another embodiment, the samples of experimental miRNA may be isolated from a subject or group of subjects suspected of being afflicted or afflicted with one or more neurological conditions. Control miRNA may be derived from a nucleic acid sample of a subject or group of subjects which are not afflicted with the neurological conditions that the subjects from which the experimental miRNA was derived. In another embodiment, the subjects from which the experimental and control samples are derived may both be suspected of being afflicted or afflicted with the condition, but the severity of the condition or a treatment plan in the two subject groups may differ.

A related aspect of the invention provides a method of determining a gene profile or microRNA profile for the administration of a therapeutic treatment to a subject. Such methods are useful to detect the gene expression changes that accompany the underlying therapeutic treatments. A gene profile or microRNA profile for such genetic changes may be used to determine if a second therapeutic treatment is expected to have the same effect, by comparing the gene expression profile or microRNA profile of the second treatment to the gene profile or microRNA profile of the first.

Accordingly, one specific aspect of the invention provides a method of determining a gene profile or microRNA profile indicative for the administration of a therapeutic treatment to a subject, the method comprising (i) preparing samples of control and experimental miRNA, wherein the experimental miRNA is generated from a nucleic acid sample isolated from a subject who has received or is receiving the therapeutic treatment; (ii) preparing one or more microarrays comprising a plurality of different oligonucleotides wherein the oligonucleotides are specific to genes associated with an autism spectrum disorder; (iii) applying the prepared samples to the one or more microarrays to allow hybridization between the oligonucleotides and the control and experimental miRNAs; (v) identifying the oligonucleotides on the microarray which display differential hybridization to the experimental miRNA relative to the control miRNA; (vi) identifying a set of genes or microRNAs associated with an autism spectrum disorder from the oligonucleotides identified in step (v) thereby determining a gene profile or microRNA profile for the administration of the therapeutic treatment to the subject.

In yet another aspect of the invention, a method is provided for determining a gene profile or microRNA profile for at least one autism spectrum disorder, comprising (a) preparing samples of control and experimental miRNA, wherein the experimental miRNA is generated from a nucleic acid sample isolated from a subject suspected of being afflicted with the at least one autism spectrum disorder and the control miRNA is generated from a nucleic acid sample isolated from a healthy individual; (b) preparing one or more microarrays comprising a plurality of different oligonucleotides having specificity for genes or or microRNAs associated with the at least one autism spectrum disorder; (c) applying the prepared samples to the one or more microarrays to allow hybridization between the oligonucleotides and the control miRNA and the oligonucleotide and the experimental miRNAs; (d) identifying the oligonucleotides on the microarray which display differential hybridization to the experimental miRNA relative to the control miRNA thereby determining a gene profile or microRNA profile for the at least one autism spectrum disorder.

In yet another aspect of the invention, a method is provided for distinguishing between different phenotypes of an autism spectrum disorder comprising severely language impaired (L), mildly affected (M), or “savants” (S) comprising (a) preparing samples of control and experimental miRNA, wherein the experimental miRNA is generated from a nucleic acid sample isolated from a subject suspected of being afflicted with at least one phenotype comprising the severely language impaired (L), mildly affected (M), or “savants” (S); (b) preparing one or more microarrays comprising a plurality of different oligonucleotides having specificity for genes or microRNAs associated with the at least one phenotype; (c) applying the prepared samples to the one or more microarrays to allow hybridization between the oligonucleotides and the control and experimental miRNAs; (d) identifying the oligonucleotides on the microarray which display differential hybridization to the experimental miRNA relative to the control miRNA thereby determining a gene profile or microRNA profile for distinguishing among the different phenotypes of autism spectrum disorder.

In yet another embodiment of the screening method of the present invention, the method distinguishes between different variants of autism spectrum disorder comprising a lower severity scores across all ADIR items, an intermediate severity across all ADIR items, a higher severity scores on spoken language items on the ADIR, a higher frequency of savant skills, and a severe language impairment, or a combination thereof.

In one embodiment of the methods for determining a gene profile or microRNA profile for the administration of a therapeutic treatment, administration of therapeutic treatment results in a physiological change in the subject, such as a beneficial change. In a specific embodiment, the physiological change comprises one or more improvements in social interaction, language abilities, restricted interests, repetitive behaviors, sleep disorders, seizures, gastrointestinal, hepatic, and mitochondrial function, neural inflammation, or a combination thereof. In another embodiment, the control miRNA may be derived from the subject(s) prior to administration of the therapeutic treatment, or from a subject or group of subjects who do not receive the therapeutic treatment.

In another embodiment of the methods for determining a gene profile or microRNA profile for the administration of a therapeutic treatment to a subject suspected of being afflicted with or afflicted with autism spectrum disorder conditions including autistic disorder, pervasive developmental disorder-not otherwise specified (PDD-NOS), including atypical autism, Asperger's Disorder, the therapeutic treatment may comprise a single procedure or it may comprise an aggregate of treatment procedures. In one embodiment, therapeutic treatment comprises a behavioral therapy, such as applied behavior analysis (ABA) intervention methods, dietary changes, exercise, massage therapy, group therapy, talk therapy, play therapy, conditioning, or alternative therapies such as sensory integration and auditory integration therapies. In another embodiment, the therapeutic treatment comprises administering to the subject a drug, such as an antidepressant or antipsychotic drug. In another embodiment, the subject is afflicted with a neurological condition other than autism spectrum disorder conditions including autistic disorder, pervasive developmental disorder-not otherwise specified (PDD-NOS), including atypical autism, Asperger's Disorder. Such condition may be one which the therapeutic treatment is intended to treat. In another embodiment, the subject is a healthy subject who is not afflicted with a neurological condition. In another embodiment, the therapeutic treatment is a treatment for the autism spectrum disorder neurological conditions including autistic disorder, pervasive developmental disorder-not otherwise specified (PDD-NOS), including atypical autism, Asperger's Disorder.

In another embodiment, the drug being administered in the single procedure or the aggregate of treatment procedures is a serotonergic antidepressant medication, such as one selected from the group consisting of citalopram, fluoxetine, fluvoxamine, paroxetine, or sertraline, or the drug is a catecholaminergic antidepressant medication, such as bupropion.

In another preferred embodiment of the ongoing methods, both the control miRNA and the experimental miRNA are derived from a nucleic acid sample isolated from the subject. Samples may be isolated from a mammal, such as a human. In a specific embodiment, the sample is isolated post-mortem from a human. Nucleic acid samples may be isolated from any tissue or bodily fluid, including blood, saliva, tears, cerebrospinal fluid, pericardial fluid, synovial fluid, aminiotic fluid, semen, bile, ear wax, gastric acid, sweat, urine, or fluid drained from an edema. In a further specific embodiment, the nucleic acid sample is isolated from lymphoblastoid cells or lyphoblastoid cell lines (LCL) derived from blood cells of subjects. In some embodiments of the ongoing methods, the sample is isolated from a neuronal tissue or a combination of tissue types, such as olfactory bulb cells, cerebrospinal fluid, hypothalamus, amygdala, pituitary, spinal cord, brainstem, cerebellum, cortex, frontal cortex, hippocampus, choroid plexus, striatum, and thalamus.

In one embodiment of the ongoing methods, the microarray is any one of the microarrays, or gene chips or microRNA chips described herein. In a preferred embodiment, the oligonucleotides on the microarray comprise those specific to microRNAs selected from Table 1, Table 2, or a combination thereof. In a specific embodiment, the oligonucleotides of the microarray are specific to genes associated with circadian rhythm, WNT signaling, axon guidance, regulation of the cytoskeleton, and dendrite branching, Type II Diabetes Mellitus, insulin signaling pathways, cholesterol metabolism and steroid hormone biosynthesis pathways as described supra. In a preferred embodiment, at least 10%, 20%, 30%, 40%, 50%, 60%, 70%, 80%, 90%, 95%, or 99% of the genes on the microarray are specific to mircoRNAs selected from Table 1, Table 2, or a combination thereof.

In another embodiment of the ongoing methods, the control miRNA and the experimental miRNAs are hydridized to the same microarray, while in another embodiment they are hybridized to separate but substantially identical microarrays. If the same microarray is used, the miRNA samples may be labeled using fluorescent compounds having different emission wavelengths such that the signals generated by each miRNA type may be distinguished from a single microarray.

In yet another embodiment of the ongoing methods, the control and experimental miRNA is isolated from one or more subjects. In one embodiment, the control miRNA and experimental miRNA are isolated each from at least 3, 5, 10, 15 or 20 subjects. The miRNAs from each subject may be hybridized to the microarrays separately, or the control miRNAs, or the experimental miRNAs, may be pooled together, such that, for example, an experimental miRNA sample is derived from multiple subjects. In preferred embodiments, the subjects are mammals, such as rodents, primates or humans.

In one embodiment of the ongoing methods, the set of genes or microRNAs in the gene profile or microRNA profile comprise genes or microRNAs which have a differential expression in the experimental miRNA relative to the control miRNA. Differential expression may refer to a lower expression level or to a higher expression. In preferred embodiments, the difference in expression level is statistically significant for each gene or microRNA, or marker, on the set. In preferred embodiments, the difference in expression is at least 10%, 20%, 30%, 40%, 50%, 60%, 70%, 80%, 90%, 100%, 150%, 200%, 300%, 400%, or 500% greater in the experimental miRNA than in the control miRNA, or vice versa. In another preferred embodiment, the difference in expression is at least about 1.22-fold, 1.5-fold, 2-fold, 2.5-fold, 3-fold, 3.5-fold, 4-fold, 4.5-fold, 5-fold, 6-fold, 7-fold, 8-fold, 9-fold, 10-fold, 12-fold, 14-fold, 16-fold, 18-fold, 20-fold, 25-fold, 30-fold, 35-fold, 40-fold, 45-fold, 50-fold, 55-fold, 60-fold, 65-fold, 70-fold, 75-fold, 80-fold, 85-fold, 90-fold, 95-fold, 100-fold greater (or intermediate ranges thereof as another example) in the experimental miRNA than in the control miRNA, or vice versa A gene profile may comprise all the genes or microRNAs which are differentially expressed between the control and experimental miRNAs or it may comprise a subset of those genes. In some embodiments, the gene profile comprises at least 1%, 2%, 3%, 4%, 5%, 10%, 20%, 30%, 40%, 50%, 60%, 70%, 80%, 90%, 95%, 98%, 99% or 100% (or intermediate ranges thereof as another example) of the genes or microRNAs having differential expression. Genes or microRNAs showing large, reproducible changes in expression between the two samples are preferred in some embodiments. In preferred embodiments, the gene profile or microRNA profile further comprises a subset of values associated with the expression level of each of the genes or microRNAs in the profile, such that gene profile or microRNA profile allows the identification of a biological and/or pathological condition, an agent and/or its biological mechanism of action, or a physiological process.

The preparation of samples of control and experimental miRNA may be carried out using techniques known in the art. The miRNA molecules analyzed by the present invention may be from any clinically relevant source. In one embodiment, the miRNA is derived from RNA, including, but by no means limited to, total cellular RNA, poly(A).sup.+messenger RNA (mRNA) or fraction thereof, cytoplasmic mRNA, or RNA transcribed from miRNA (i.e., cRNA; see, e.g., U.S. Pat. Nos. 5,545,522, 5,891,636, or 5,716,785). Methods for preparing total and poly(A).sup.+RNA are well known in the art, and are described generally, e.g., in Sambrook et al., MOLECULAR CLONING—A LABORATORY MANUAL (2ND ED.), Vols. 1-3, Cold Spring Harbor Laboratory, Cold Spring Harbor, N.Y. (1989). In one embodiment, RNA is extracted from a sample of cells of the various tissue types of interest, such as the lymphoblastoid cell or lymphoblastoid cell line derived therefrom or from the aforementioned neuronal tissue types, using guanidinium thiocyanate lysis followed by CsCl centrifugation (Chirgwin et al., 1979, Biochemistry 18:5294-5299). In another embodiment, total RNA is extracted using a silica gel-based column, commercially available examples of which include RNeasy (Qiagen, Valencia, Calif.) and StrataPrep (Stratagene, La Jolla, Calif.). Poly(A).sup.+RNA can be selected, e.g., by selection with oligo-dT cellulose or, alternatively, by oligo-dT primed reverse transcription of total cellular RNA. In one embodiment, RNA can be fragmented by methods known in the art, e.g., by incubation with ZnCl.sub.2, to generate fragments of RNA. In another embodiment, the polynucleotide molecules analyzed by the invention comprise miRNA, or PCR products of amplified RNA or miRNA. miRNA molecules that are poorly expressed in particular cells may be enriched using normalization techniques (Bonaldo et al., 1996, Genome Res. 6:791-806).

The miRNAs may be detectably labeled at one or more nucleotides. Any method known in the art may be used to detectably label the miRNAs. Preferably, this labeling incorporates the label uniformly along the length of the RNA, and more preferably, the labeling is carried out at a high degree of efficiency. One embodiment for this labeling uses oligo-dT primed reverse transcription to incorporate the label; however, conventional methods of this method are biased toward generating 3′ end fragments. Thus, in a preferred embodiment, random primers (e.g., 9-mers) are used in reverse transcription to uniformly incorporate labeled nucleotides over the full length of the miRNAs. Alternatively, random primers may be used in conjunction with PCR methods or T7 promoter-based in vitro transcription methods in order to amplify the miRNAs.

In one embodiment, the detectable label is a luminescent label. For example, fluorescent labels, bioluminescent labels, chemiluminescent labels, and colorimetric labels may be used in the present invention. In one preferred embodiment, the label is a fluorescent label, such as a fluorescein, a phosphor, a rhodamine, or a polymethine dye derivative. Examples of commercially available fluorescent labels include, for example, fluorescent phosphoramidites such as FluorePrime (Amersham Pharmacia, Piscataway, N.J.), Fluoredite (Millipore, Bedford, Mass.), FAM (ABI, Foster City, Calif.), and Cy3 or Cy5 (Amersham Pharmacia, Piscataway, N.J.). In another embodiment, the detectable label is a radiolabeled nucleotide.

In a further preferred embodiment, the experimental miRNAs are labeled differentially from the control miRNA, especially if both the miRNA types are hybridized to the same microarray. The control miRNA can comprise target polynucleotide molecules from normal individuals (i.e., those not afflicted with the neurological disorder or subjects who have not undergone to therapeutic treatment). In one preferred embodiment, the control miRNA comprises target polynucleotide molecules pooled from samples from normal individuals. In one embodiment of the methods for generating a gene profile or microRNA profile of a therapeutic treatment, the control miRNA is derived from the same subject, but taken at a different time point, such as before, during or after the therapeutic treatment.

Nucleic acid hybridization and wash conditions are chosen so that the miRNA molecules specifically bind or specifically hybridize to the complementary polynucleotide sequences of the array, preferably to a specific array site, wherein its complementary DNA is located. Arrays containing double-stranded probe DNA situated thereon are preferably subjected to denaturing conditions to render the DNA single-stranded prior to contacting with the miRNA molecules. Arrays containing single-stranded probe DNA (e.g., synthetic oligodeoxyribonucleic acids) may need to be denatured prior to contacting with the miRNA molecules. Optimal hybridization conditions will depend on the length (e.g., oligomer versus polynucleotide greater than 200 bases) and type (e.g., RNA, or DNA) of probe and target nucleic acids. One of skill in the art will appreciate that as the oligonucleotides become shorter, it may become necessary to adjust their length to achieve a relatively uniform melting temperature for satisfactory hybridization results. General parameters for specific (i.e., stringent) hybridization conditions for nucleic acids are described in Sambrook et al., MOLECULAR CLONING—A LABORATORY MANUAL (2ND ED.), Vols. 1-3, Cold Spring Harbor Laboratory, Cold Spring Harbor, N.Y. (1989), and in Ausubel et al., CURRENT PROTOCOLS 1N MOLECULAR BIOLOGY, vol. 2, Current Protocols Publishing, New York (1994). Typical hybridization conditions for the miRNA microarrays of Schena et al. are hybridization in 5.times.SSC plus 0.2% SDS at 65° C. for four hours, followed by washes at 25° C. in low stringency wash buffer (1.times.SSC plus 0.2% SDS), followed by 10 minutes at 25° C. in higher stringency wash buffer (0.1.times.SSC plus 0.2% SDS) (Schena et al., Proc. Natl. Acad. Sci. U.S.A. 93:10614 (1993)). Useful hybridization conditions are also provided in, e.g., Tijessen, 1993, HYBRIDIZATION WITH NUCLEIC ACID PROBES, Elsevier Science Publishers B. V.; and Kricka, 1992, NONISOTOPIC DNA PROBE TECHNIQUES, Academic Press, San Diego, Calif. Hybridization conditions may include hybridization at a temperature at or near the mean melting temperature of the probes (e.g., within 5° C., more preferably within 2° C.) in 1 M NaCl, 50 mM MES buffer (pH 6.5), 0.5% sodium sarcosine and 30% formamide.

When fluorescently labeled miRNAs are used in the aforementioned methods, the fluorescence emissions at each site of a microarray may be, preferably, detected by scanning confocal laser microscopy. In one embodiment, a separate scan, using the appropriate excitation line, is carried out for each of the two fluorophores used. Alternatively, a laser may be used that allows simultaneous specimen illumination at wavelengths specific to the two fluorophores and emissions from the two fluorophores can be analyzed simultaneously (see Shalon et al., 1996, “A DNA microarray system for analyzing complex DNA samples using two-color fluorescent probe hybridization,” Genome Research 6:639-645, which is incorporated by reference in its entirety for all purposes). In one preferred embodiment, the arrays are scanned with a laser fluorescent scanner with a computer controlled X-Y stage and a microscope objective. Sequential excitation of the two fluorophores is achieved with a multi-line, mixed gas laser and the emitted light is split by wavelength and detected with two photomultiplier tubes. Fluorescence laser scanning devices are described in Schena et al., Genome Res. 6:639-645 (1996), and in other references cited herein. Alternatively, the fiber-optic bundle described by Ferguson et al., Nature Biotech. 14:1681-1684 (1996), may be used to monitor mRNA or microRNA abundance levels at a large number of sites simultaneously.

Signals may be recorded and, in a preferred embodiment, analyzed by computer, e.g., using a 12 or 16 bit analog to digital board. In one embodiment the scanned image is despeckled using a graphics program (e.g., Hijaak Graphics Suite) and then analyzed using an image gridding program that creates a spreadsheet of the average hybridization at each wavelength at each site. If necessary, an experimentally determined correction for “cross talk” (or overlap) between the channels for the two fluors may be made. For any particular hybridization site on the transcript array, a ratio of the emission of the two fluorophores can be calculated. The ratio is independent of the absolute expression level of the cognate gene or microRNA, but is useful for genes or microRNAs whose expression is significantly modulated in association with the different neurological conditions.

In another embodiment of the present invention, changes in gene expression or microRNA expression may be assayed in at least one cell of a subject by measuring transcriptional initiation, transcript stability, translation of transcript into protein product, protein stability, or a combination thereof. The gene, microRNA, transcript, or polypeptide can be assayed by techniques such as in vitro transcription, quantitative nuclease protection assay (qNPA) analysis, focused gene chip analysis, Northern hybridization, nucleic acid hybridization, reverse transcription-polymerase chain reaction (RT-PCR), run-on transcription, Southern hybridization, electrophoretic mobility shift assay (EMSA), fluorescent or histochemical staining, microscopy and digital image analysis, and fluorescence activated cell analysis or sorting (FACS).

A reporter or selectable marker gene whose protein product is easily assayed may be used for convenient detection. Reporter genes include, for example, alkaline phosphatase, .beta.-galactosidase (LacZ), chloramphenicol acetyltransferase (CAT), .beta.-glucoronidase (GUS), bacterial/insect/marine invertebrate luciferases (LUC), green and red fluorescent proteins (GFP and RFP, respectively), horseradish peroxidase (HRP), .beta.-lactamase, and derivatives thereof (e.g., blue EBFP, cyan ECFP, yellow-green EYFP, destabilized GFP variants, stabilized GFP variants, or fusion variants sold as LIVING COLORS fluorescent proteins by Clontech). Reporter genes would use cognate substrates that are preferably assayed by a chromogen, fluorescent, or luminescent signal. Alternatively, assay product may be tagged with a heterologous epitope (e.g., FLAG, MYC, SV40 T antigen, glutathione transferase, hexahistidine, maltose binding protein) for which cognate antibodies or affinity resins are available.

In another embodiment, the gene or transcriptcan be assayed by use systems employing expression vectors. An expression vector is a recombinant polynucleotide that is in chemical form either a deoxyribonucleic acid (DNA) and/or a ribonucleic acid (RNA). The physical form of the expression vector may also vary in strandedness (e.g., single-stranded or double-stranded) and topology (e.g., linear or circular). The expression vector is preferably a double-stranded deoxyribonucleic acid (dsDNA) or is converted into a dsDNA after introduction into a cell (e.g., insertion of a retrovirus into a host genome as a provirus). The expression vector may include one or more regions from a mammalian gene expressed in the microvasculature, especially endothelial cells (e.g., ICAM-2, tie), or a virus (e.g., adenovirus, adeno-associated virus, cytomegalovirus, fowlpox virus, herpes simplex virus, lentivirus, Moloney leukemia virus, mouse mammary tumor virus, Rous sarcoma virus, SV40 virus, vaccinia virus), as well as regions suitable for genetic manipulation (e.g., selectable marker, linker with multiple recognition sites for restriction endonucleases, promoter for in vitro transcription, primer annealing sites for in vitro replication). The expression vector may be associated with proteins and other nucleic acids in a carrier (e.g., packaged in a viral particle) or condensed with chemicals (e.g., cationic polymers) to target entry into a cell or tissue.

The expression vector further comprises a regulatory region for gene expression (e.g., promoter, enhancer, silencer, splice donor and acceptor sites, polyadenylation signal, cellular localization sequence). Transcription can be regulated by tetracyline or dimerized macrolides. The expression vector may be further comprised of one or more splice donor and acceptor sites within an expressed region; Kozak consensus sequence upstream of an expressed region for initiation of translation; and downstream of an expressed region, multiple stop codons in the three forward reading frames to ensure termination of translation, one or more mRNA degradation signals, a termination of transcription signal, a polyadenylation signal, and a 3′ cleavage signal. For expressed regions that do not contain an intron (e.g., a coding region from a miRNA), a pair of splice donor and acceptor sites may or may not be preferred. It would be useful, however, to include mRNA degradation signal(s) if it is desired to express one or more of the downstream regions only under the inducing condition. An origin of replication may also be included that allows replication of the expression vector integrated in the host genome or as an autonomously replicating episome. Centromere and telomere sequences can also be included for the purposes of chromosomal segregation and protecting chromosomal ends from shortening, respectively. Random or targeted integration into the host genome is more likely to ensure maintenance of the expression vector but episomes could be maintained by selective pressure or, alternatively, may be preferred for those applications in which the expression vector is present only transiently.

An expressed region may be derived from any gene of interest, and be provided in either orientation with respect to the promoter; the expressed region in the antisense orientation will be useful for making cRNA and antisense polynucleotide. The gene may be derived from the host cell or organism, from the same species thereof, or designed de novo; but it is preferably of archael, bacterial, fungal, plant, or animal origin. The gene may have a physiological function of one or more nonexclusive classes: axon guidance, synaptic transmission or plasticity, myelination, long-term potentiation, neuron toxicity, embryonic development, regulation of actin networks, KEGG pathway, digestion, liver toxicity (hepatic stellate cell activation, fibrosis, and cholestasis), inflammation, oxidative stress, epilepsy, apoptosis, cell survival, differentiation, the unfolded protein response, Type II diabetes and insulin signaling, endocrine function, circadian rhythm, cholesterol metabolism and the steroidogenesis pathway, adhesion proteins; steroids, cytokines, hormones, and other regulators of cell growth, mitosis, meiosis, apoptosis, differentiation, circadian rthym, or development; soluble or membrane receptors for such factors; adhesion molecules; cell-surface receptors and ligands thereof; cytoskeletal and extracellular matrix proteins; cluster differentiation (CD) antigens, antibody and T-cell antigen receptor chains, histocompatibility antigens, and other factors mediating specific recognition in immunity; chemokines, receptors thereof, and other factors involved in inflammation; enzymes producing lipid mediators of inflammation and regulators thereof; clotting and complement factors; ion channels and pumps; transporters and binding proteins; neurotransmitters, neurotrophic factors, and receptors thereof; cell cycle regulators, oncogenes, and tumor suppressors; other transducers or components of signaling pathways; proteases and inhibitors thereof; catabolic or metabolic enzymes, and regulators thereof. Some genes produce alternative transcripts, encode subunits that are assembled as homopolymers or heteropolymers, or produce propeptides that are activated by protease cleavage. The expressed region may encode a translational fusion; open reading frames of the regions encoding a polypeptide and at least one heterologous domain may be ligated in register. If a reporter or selectable marker is used as the heterologous domain, then expression of the fusion protein may be readily assayed or localized. The heterologous domain may be an affinity or epitope tag.

Methods of Identifying or Characterizing Therapeutic Compounds

Another aspect of the invention is identification or screening of chemical or genetic compounds, derivatives thereof, and compositions including same that are effective in treatment of neurological diseases or disorders and individuals at risk thereof. The amount that is administered to an individual in need of therapy or prophylaxis, its formulation, and the timing and route of delivery is effective to reduce the number or severity of symptoms, to slow or limit progression of symptoms, to inhibit expression of one or more of the aforementioned genes or microRNAs that are transcribed at a higher level in neurological disease, to activate expression of one or more of the aforementioned genes or microRNAs that are transcribed at a lower level in neurological disease, or any combination thereof. Determination of such amounts, formulations, and timing and route of drug delivery is within the skill of persons conducting in vitro assays, in vivo studies of animal models, and human clinical trials.

A screening method may comprise administering a candidate compound to an organism or incubating a candidate compound with a cell, and then determining whether or not gene or microRNA expression is modulated. Such modulation may be an increase or decrease in activity that partially or fully compensates for a change that is associated with or may cause neurological disease. Gene or microRNA expression may be increased at the level of rate of transcriptional initiation, rate of transcriptional elongation, stability of transcript, translation of transcript, rate of translational initiation, rate of translational elongation, stability of protein, rate of protein folding, proportion of protein in active conformation, functional efficiency of protein (e.g., activation or repression of transcription), or combinations thereof. See, for example, U.S. Pat. Nos. 5,071,773 and 5,262,300. High-throughput screening assays are possible (e.g., by using parallel processing and/or robotics).

The screening method may comprise incubating a candidate compound with a cell containing a reporter construct, the reporter construct comprising transcription regulatory region covalently linked in a cis configuration to a downstream gene encoding an assayable product; and measuring production of the assayable product. A candidate compound which increases production of the assayable product would be identified as an agent which activates gene or microRNA expression while a candidate compound which decreases production of the assayable product would be identified as an agent which inhibits gene or microRNA expression. See, for example, U.S. Pat. Nos. 5,849,493 and 5,863,733.

The screening method may comprise measuring in vitro transcription from a reporter construct in the presence or absence of a candidate compound (the reporter construct comprising a transcription regulatory region) and then determining whether transcription is altered by the presence of the candidate compound. In vitro transcription may be assayed using a cell-free extract, partially purified fractions of the cell, purified transcription factors or RNA polymerase, or combinations thereof. See, for example, U.S. Pat. Nos. 5,453,362, 5,534,410, 5,563,036, 5,637,686, 5,708,158 and 5,710,025.

Techniques for measuring transcriptional or translational activity in vivo are known in the art. For example, a nuclear run-on assay may be employed to measure transcription of a reporter gene. Translation of the reporter gene may be measured by determining the activity of the translation product. The activity of a reporter gene can be measured by determining one or more of transcription of polynucleotide product (e.g., RT-PCR of GFP transcripts), translation of polypeptide product (e.g., immunoassay of GFP protein), and enzymatic activity of the reporter protein per se (e.g., fluorescence of GFP or energy transfer thereof).

Another aspect of the invention provides methods of identifying, or predicting the efficacy of, test compounds. In particular, the invention provides methods of identifying compounds which mimic the effects of behavioral therapies. In still another aspect, the systems and methods described herein provide a method for predicting efficacy of a test compound for altering a behavioral response, by obtaining a database, e.g., as described in greater detail above, treating a test animal or human (e.g., a control animal or human that has not undergone other therapies, such as behavioral therapy) with the test compound, and comparing genetic or microRNA expression data of tissue samples from the animal or human treated with the test compound to measure a degree of similarity with one or more gene profiles or microRNA profiles in said database. In certain embodiments, the untreated animal or human exhibits a psychological and/or behavioral abnormality possessed by the animals or humans used to generate the database prior to administration of the behavioral therapy.

In another aspect of the invention, a method is provided for predicting efficacy of a test compound for altering a behavioral response in a subject with at least one autism spectrum disorder comprising: (a) preparing a microarray comprising a plurality of different oligonucleotides, wherein the oligonucleotides are specific to genes or microRNAs associated with an autism spectrum disorder; (b) obtaining a gene profile or microRNA profile representative of the gene expression profile or microRNA expression profile of at least one sample of a selected tissue type from a subject subjected to each of at least one of a plurality of selected behavioral therapies which promote the behavioral response; (c) administering the test compound to the subject; and (d) comparing gene expression profile or microRNA expression profile data in at least one sample of the selected tissue type from the subject treated with the test compound to determine a degree of similarity with one or more gene profiles or microRNA profiles associated with an autism spectrum disorder; wherein the predicted efficacy of the test compound for altering the behavioral response is correlated to said degree of similarity.

In another aspect, the systems and methods described herein relate to methods of identifying small molecules useful for treating neurological conditions.

For example, in another embodiment a database of gene profile or microRNA profile data representative of the genetic expression response of a selected neuronal tissue type from an animal that was subjected to at least one of a plurality of behavioral therapies and that has undergone a selected physiological change since commencement of the behavioral therapy may be obtained. In an exemplary embodiment, subjects (e.g., subjects that display a preselected behavioral abnormality, such as an autism spectrum disorder neurological condition (including for example autistic disorder, pervasive developmental disorder-not otherwise specified (PDD-NOS), including atypical autism, Asperger's Disorder, Rett's syndrome), Parkinson's disease, parkinsonism, cognitive impairments, age-associated memory impairments, cognitive impairments, dementia associated with neurologic and/or neurological conditions, allodynia, catalepsy, hypernocieption, and epilepsy, brain tumors, brain lesions, multiple sclerosis, Down's syndrome, progressive supranuclear palsy, frontal lobe syndrome, schizophrenia, delirium, Tourette's syndrome, myasthenia gravis, attention deficit hyperactivity disorder, dyslexia, mania, depression, apathy, myopathy, Alzheimer's disease, Huntington's Disease, dementia, encephalopathy, schizophrenia, severe clinical depression, brain injury, Attention Deficit Disorder (ADD), Attention Deficit Hyperactivity Disorder (ADHD), hyperactivity disorder, bipolar manic-depressive disorder, ischemia, alcohol addiction, drug addiction, obsessive compulsive disorders, Pick's disease and Binswanger's disease or a combination thereof), are subjected to behavioral therapy (including, for example, applied behavior analysis (ABA) intervention methods, dietary changes, exercise, massage therapy, group therapy, talk therapy, play therapy, conditioning, or alternative therapies such as sensory integration and auditory integration therapies), and their tissues (including, for example, and not by way of limitation, lymphocytes, blood, or mucosal epithelial cells, brain, spinal cord, heart, arteries, esophagus, stomach, small intestine, large intestine, liver, pancreas, lungs, kidney, urinary tract, ovaries, breasts, uterus, testis, penis, colon, prostate, bone, muscle, cartilage, thyroid gland, adrenal gland, pituitary, bone marrow, blood, thymus, spleen, lymph nodes, skin, eye, ear, nose, teeth or tongue, and/or neurological tissues (including, for example, and not by way of limitation, olfactory bulb cells, cerebrospinal fluid, hypothalamus, amygdala, pituitary, nervous system, brainstem, cerebellum, cortex, frontal cortex, hippocampus, striatum, and thalamus) or a combination thereof are examined for physiological changes (one or more improvements in social interaction, language abilities, restricted interests, repetitive behaviors, sleep disorders, seizures, gastrointestinal, hepatic, and mitochondrial function, neural inflammation, or a combination thereof), and genetic expression responses are obtained for tissues that have undergone a desired change. In certain embodiments, the subjects are further selected for having undergone a desired change in behavior as well.

From such a database, biological targets for intervention can be identified, such as potential therapeutics (e.g., genes or microRNAs that are upregulated and thus may exert a beneficial effect on the physiology and/or behavior of the subject), potential receptor targets (e.g., receptors associated with upregulated proteins, the activation of which receptors may exert a beneficial effect on the physiology and/or behavior of the subject; or receptors associated with downregulated proteins, the inhibition of which may exert a beneficial effect on the physiology and/or behavior of the subject). In certain embodiments, one or more genes or one or more microRNAs, the expression of which differs by a statistically significant amount in a treated subject as compared to an untreated control, may be selected as targets for intervention.

Small molecule test agents may then be screened in any of a number of assays to identify those with potential therapeutic applications. The term “small molecule” refers to a compound having a molecular weight less than about 2500 amu, preferably less than about 2000 amu, even more preferably less than about 1500 amu, still more preferably less than about 1000 amu, or most preferably less than about 750 amu. For example, subjects or tissue samples may be treated with such test agents to identify those that produce similar changes in expression of the targets, or produce similar gene profiles or microRNA profiles, as can be obtained by administration of behavioral therapy. Alternatively or additionally, such test agents may be screened against one or more target receptors to identify compounds that agonize or antagonize these receptors, singly or in combination, e.g., so as to reproduce or mimic the effect of behavioral therapy.

Compounds that induce a desired effect on targets, tissue, or subjects may then be selected for clinical development, and may be subjected to further testing, e.g., therapeutic profiling, such as testing for efficacy and toxicity in subjects. Analogs of selected compounds, e.g., compounds having similar cores but varying substituents and stereochemistry, may similarly be developed and tested. Agents that have acceptable characteristics for therapeutic use in humans or animals may be prepared as pharmaceutical preparations, e.g., with a pharmaceutically acceptable excipient (such as a non-pyrogenic or sterile excipient). Such agents may also be licensed to a manufacturer for development and/or commercialization, e.g., for manufacture and sale of a pharmaceutical preparation comprising said selected agent.

Accordingly, one aspect of the invention provides a method for predicting efficacy of a test compound for altering a behavioral response in a subject with at least one autism spectrum disorder comprising: (a) preparing a microarray comprising a plurality of different oligonucleotides, wherein the oligonucleotides are specific to genes or microRNAs associated with an autism spectrum disorder; (b) obtaining a gene profile or microRNA profile representative of the gene expression profile or microRNA expression profile of at least one sample of a selected tissue type from a subject subjected to each of at least one of a plurality of selected behavioral therapies which promote the behavioral response; (c) administering the test compound to the subject; and (d) comparing gene expression profile or microRNA expression profile data in at least one sample of the selected tissue type from the subject treated with the test compound to determine a degree of similarity with one or more gene profiles or microRNA profiles associated with an autism spectrum disorder; wherein the predicted efficacy of the test compound for altering the behavioral response is correlated to said degree of similarity.

In one embodiment of the foregoing methods, step (a) comprises obtaining a gene profile or microRNA profile representative of the gene expression profile or microRNA expression profile of at least two samples of a selected tissue type referred to supra. In a related embodiment, step (a) comprises obtaining a gene profile or microRNA profile data representative of the gene expression profile of at least three samples of a selected tissue referred to supra. In one embodiment in which the more than one sample of a selected tissue type referred to supra is used to determine a gene profile or microRNA profile, the selected tissue types are different tissue types, whereas in other embodiments the tissue types are the same. For example, in an exemplary embodiment, a tissue type may be lymphoblastoid cells and a second tissue type olfactory bulb cells, such that the gene expression profile data or microRNA expression profile generated from these two tissue samples in the treated subject may be compared to the gene profiles or microRNA profiles derived from the subjects subjected to the behavioral therapy. In other embodiments, gene profiles or microRNA profiles may be generated from multiple samples of the same tissue type from the same animal, such as blood samples taken at different intervals during the behavioral therapy.

In another embodiment of the foregoing methods, the gene profile or microRNA profile is that shown in Table 1, Table 2, or a combination thereof. In another embodiment, the gene profile or microRNA profile comprises at least 5%, 10%, 20%, 30%, 40%, 50%, 60%, 70%, 80%, 90%, 95% or 98% of the microRNAs shown in Table 1, Table 2, or a combination thereof. In another embodiment, the gene profile or microRNA profile comprises at least 5, 10, 15, 20, 25 or 30 of the microRNAs listed in Table 1, Table 2, or a combination thereof. In yet another embodiment of the foregoing methods, the gene profile comprises an increase or a decrease in expression of at least one to 94, or any integer value thereof, of any of the target genes listed in Table 3 or a combination thereof.

In one embodiment of the foregoing methods, the selected tissue type comprises a neuronal tissue type, such as a neuronal tissue type selected from the group consisting of olfactory bulb cells, cerebrospinal fluid, hypothalamus, amygdala, pituitary, nervous system, brainstem, cerebellum, cortex, frontal cortex, hippocampus, striatum, and thalamus. In another embodiment, the selected tissue type is selected from the group consisting of brain, spinal cord, heart, arteries, esophagus, stomach, small intestine, large intestine, liver, pancreas, lungs, kidney, urinary tract, ovaries, breasts, uterus, testis, penis, colon, prostate, bone, muscle, cartilage, thyroid gland, adrenal gland, pituitary, bone marrow, blood, thymus, spleen, lymph nodes, skin, eye, ear, nose, teeth and tongue.

In one embodiment, the behavioral therapy comprises applied behavior analysis (ABA) intervention methods, dietary changes, exercise, massage therapy, group therapy, talk therapy, play therapy, conditioning, or alternative therapies such as sensory integration and auditory integration therapies.

In one embodiment of the foregoing methods, the test subject or animal is a human. In another embodiment, the animal is a non-human animal. Such non-human animals include vertebrates such as rodents, non-human primates, ovines, bovines, ruminants, lagomorphs, porcines, caprines, equines, canines, felines, ayes, etc. Preferred non-human animals are selected from the order Rodentia, most preferably mice. The term “order Rodentia” refers to rodents (i.e., placental mammals (Class Euthria) which include the family Muridae (rats and mice). In a specific embodiment, the test animal is a mammal, a primate, a rodent, a mouse, a rat, a guinea pig, a rabbit or a human.

The test compound may be administered to the subject or animal using any mode of administration, including, intravenous, subcutaneous, intramuscular, intrasternal, topical, liposome-mediate, rectal, intravaginal, opthalmic, intracranial, intraspinal or intraorbital. The test compound may be administered once or more than once as part of a treatment regimen. In some embodiments, additional test compounds or agents may be administered to the subject animal to ascertain the efficacy of the test compound or the combination of test compounds or agents. In some embodiments, a gene expression profile or microRNA expression profile may also be obtained from the subject or animal prior to treatment with the test agent. In such embodiments, the efficacy of the test agent may be determined by comparing the gene expression profile or microRNA expression profile of the subject or animal after treatment with the compound with (a) the gene expression profile or microRNA expression profile prior to treatment with the compound and (b) to the gene profile or microRNA profile for the behavioral therapy. For example, if the test compound causes the gene expression profile or microRNA expression profile to approach that of said gene profile or microRNA profile, the test compound may be predicted to be efficacious.

It is understood by one skilled in the art that the order of steps (a) and (b) in the foregoing methods may be interchanged i.e. the subject or animal may be treated with the compound prior to obtaining the genetic data profile or microRNA profile for the behavior therapy. Accordingly, the invention also provides a method wherein step (b) is performed prior to step (a).

When comparing the gene expression profile or microRNA expression profile data in at least one sample of the selected tissue type from the subject or animal treated with the test compound to determine a degree of similarity with one or more gene profiles or microRNA profiles, any number of statistical methods known to one skilled in the art may be used. In some embodiments, a gene profile or microRNA profile may be obtained from samples of a test subject or animal prior to the administration of the test compound or from a control subject or animal to generate a control gene profile or microRNA profile for each of the tissue types of interest. In such embodiments, the gene expression profile or microRNA expression profile from the tissue types of the test subjects or animal(s) may be compared to both the control gene profiles or microRNA profiles and the gene profiles or microRNA profiles resulting from the behavioral therapy to determine to which of these profiles the gene expression profile or microRNA expression profile is most similar. If they are more similar to the control gene profile or microRNA profile, the test compound may be considered to less efficacious, whereas if it is more similar to the gene profile or microRNA profile of the behavioral therapy then the compound is considered more efficacious.

In one variation of the ongoing methods, more than one test compound may be administered to the test subject or animal, such that the efficacy of a combination of test compounds is tested. In another variation, rather than using, or in addition to using, a test compound, a nonchemical test agent is also applied to the subject or animal, such as for example, and not by way of limitation, temperature, humidity, sunlight exposure or any other environmental factor. In yet another environment, the subject or animal is subjected to an invasive or noninvasive surgical procedure, in lieu or in addition to the test compound. In such embodiments, the efficacy of the surgical procedure may be ascertained.

In still yet another aspect, the systems and methods described herein relate to a kit for identifying a compound for treating a behavioral disorder, comprising a database, e.g., as described in greater detail above, and a computer program for comparing gene expression profile or microRNA expression profile data obtained from assays wherein a test compound is administered to an untreated subject or animal with gene expression profile or microRNA expression profile data in the database and identifying similarity between the gene expression profile or microRNA expression profile data from the assays and one or more stored profiles.

In yet another aspect of the invention, the systems and methods described herein relate a kit is provided for identifying a compound for treating at least one autism spectrum disorder comprising (a) a database having information stored therein one or more differential gene expression profiles or microRNA expression profiles specific for the microRNAs listed in Table 1, Table 2, or a combination thereof, of subjects that have been subjected to at least one of a plurality of selected autism spectrum disorder neurological therapies and wherein the subject has undergone a desired physiological change; and (b) a computer program for comparing gene expression profile or microRNA expression profile data obtained from assays wherein a test compound is administered to a subject with the database and providing information representative of a measure of similarity between the gene expression profile or microRNA expression profile data and one or more stored gene profiles or microRNA profiles.

Another aspect of the invention provides a method of assessing treatment efficacy in an individual having a neurological disorder comprising determining the expression level of one or more of the aforementioned informative microRNAs in Table 1, Table 2, or a combination thereof at multiple time points during treatment, wherein a decrease in expression of the one or more informative microRNAs shown to be expressed, or expressed at increased levels as compared with a control, in individuals having a neurological disorder or at risk for developing a neurological disorder, is indicative that treatment is effective.

The invention also provides a method of assessing the efficacy of a treatment in an individual having a neurological disorder, comprising (i) determining gene expression profile or microRNA expression profile data in a plurality of patient samples, obtained at multiple time points during treatment of the patient, of a selected tissue type; (ii) determining a degree of similarity between (a) the gene expression profile or microRNA expression profile data in the patient samples; and (b) a gene profile or microRNA profile produced by a therapy which has been shown to be efficacious in treatment of the neurological disorder; wherein a high degree of similarity is indicative that the treatment is effective.

In one embodiment, the invention also provides a method for assessing the efficacy of a treatment in an individual having at least one autism spectrum disorder comprising (a) determining differential gene expression profile or microRNA expression profile data specific for at least five different microRNAs set out in Table 1 or Table 2 or a combination thereof, in a plurality of patient samples of a selected tissue type; (b) determining a degree of similarity between (a) the differential gene expression profile or microRNA expression profile data in the patient samples; and (b) a differential gene profile or microRNA profile specific for the microRNAs set out in listed in Table 1, Table 2, or a combination thereof, produced by a therapy which has been shown to be efficacious in treatment of the at least one autism spectrum disorder; wherein a high degree of similarity of the differential microRNA expression profile data is indicative that the treatment is effective.

Another aspect of the invention provides kits. One aspect provides a kit for identifying a compound for treating a behavioral or neurological disorder, comprising (i) a database having information stored therein gene profile or microRNA profile data representative of the genetic or microRNA expression response of selected tissue type samples from subjects or animals that have been subjected to at least one of a plurality of selected behavioral therapies and wherein the tissue has undergone a desired physiological change; and (ii) a computer program for (a) comparing gene expression profile or microRNA profile data obtained from assays, where a test compound is administered to a subject or an animal, with the database; and (b) providing information representative of a measure of similarity between the gene expression profile or microRNA expression profile data and one or more stored profiles.

In yet another aspect of the invention, a kit is provided for identifying a compound for treating at least one autism spectrum disorder comprising (a) a database having information stored therein one or more differential gene expression or microRNA expression profiles specific for the microRNAs listed in Table 1, Table 2, or a combination thereof, of subjects that have been subjected to at least one of a plurality of selected autism spectrum disorder neurological therapies and wherein the subject has undergone a desired physiological change; and (b) a computer program for comparing gene expression profile or microRNA expression profile data obtained from assays wherein a test compound is administered to a subject with the database and providing information representative of a measure of similarity between the gene expression profile or microRNA expression profile data and one or more stored gene profiles or microRNA profiles.

In some embodiments of the methods described herein, the test compound comprises an antibody or fragment thereof, a nucleic acid molecule, antisense reagent, a small molecule drug, or a nutritional or herbal supplement. Test compounds can be screened individually, in combination with one or more other compounds, or as a library of compounds. In one embodiment, test compounds include nucleic acids, peptides, polypeptides, peptidomimetics, RNAi constructs, antisense oligonucleotides, ribozymes, antibodies, small molecules, and nutritional or herbal supplements or a combination thereof.

In general, test compounds for modulation of neurological disorders, including those autistic spectrum disorders such as autistic disorder, pervasive developmental disorder-not otherwise specified (PDD-NOS), including atypical autism, Asperger's Disorder, or a combination thereof, can be identified from large libraries of natural products or synthetic (or semi-synthetic) extracts or chemical libraries according to methods known in the art. Those skilled in the field of drug discovery and development will understand that the precise source of test extracts or compounds is not critical to the screening procedure(s) of the invention. Accordingly, virtually any number of chemical extracts or compounds can be screened using the exemplary methods described herein. Examples of such extracts or compounds include, but are not limited to, plant-, fungal-, prokaryotic- or animal-based extracts, fermentation broths, and synthetic compounds, as well as modification of existing compounds. Numerous methods are also available for generating random or directed synthesis (e.g., semi-synthesis or total synthesis) of any number of chemical compounds, including, but not limited to, saccharide-, lipid-, peptide-, and nucleic acid-based compounds. Synthetic compound libraries are commercially available, e.g., Chembridge (San Diego, Calif.). Alternatively, libraries of natural compounds in the form of bacterial, fungal, plant, and animal extracts are commercially available from a number of sources, including Biotics (Sussex, UK), Xenova (Slough, UK), Harbor Branch Oceangraphics Institute (Ft. Pierce, Fla.), and PharmaMar, U.S.A. (Cambridge, Mass.). In addition, natural and synthetically produced libraries are generated, if desired, according to methods known in the art, e.g., by standard extraction and fractionation methods. Furthermore, if desired, any library or compound is readily modified using standard chemical, physical, or biochemical methods.

Methods of Conducting Drug Discovery

Another aspect of the invention provides methods for conducting drug discovery related to the methods and gene chips or microRNA chips provided herein.

One aspect of the invention provides a method for conducting drug discovery comprising: (a) generating a database of gene profile or microRNA profile data representative of the genetic expression response of at least one selected tissue type (for example, one of the aforementioned neuronal tissue types) from a subject or an animal that was subjected to at least one of a plurality of behavioral therapies and that has undergone a selected physiological change since commencement of the behavioral therapy; (b) selecting at least one microRNA profile from Table 1, Table 2, or a combination thereof and selecting at least one target as a function of the selected gene profiles or microRNA profiles; (c) screening a plurality of small molecule test agents in assays to obtain gene expression profile or microRNA expression profile data associated with administration of the agents and comparing the obtained data with the one or more selected gene profiles or microRNA profiles; (d) selecting for clinical development test agents that exhibit a desired effect on the target as evidenced by the gene expression profile or microRNA expression profiles data; (e) for test agents selected for clinical development, conducting therapeutic profiling of the test compound, or analogs thereof, for efficacy and toxicity in subjects or animals; and (f) selecting at least one test agent that has an acceptable therapeutic and/or toxicity profile.

Another aspect of the invention provides a method for conducting drug discovery comprising: (a) generating a database of gene profile or microRNA profile data representative of the genetic expression response of at least one selected neuronal tissue type from a subject or an animal that was subjected to at least one of a plurality of behavioral therapies and that has undergone a selected physiological change since commencement of the behavioral therapy; (b) administering small molecule test agents to test subjects or animals to obtain gene expression profile or microRNA expression profile data associated with administration of the agents and comparing the obtained data with the one or more selected gene profiles or microRNA profiles; (c) selecting test agents that induce profiles similar to profiles obtainable by administration of behavioral therapy; (d) conducting therapeutic profiling of the selected test compound(s), or analogs thereof, for efficacy and toxicity in subjects or animals; and (e) identifying a pharmaceutical preparation including one or more agents identified in step (e) as having an acceptable therapeutic and/or toxicity profile.

In one embodiment, the database of gene profile or microRNA profile data representative of the genetic expression response of at least one selected neuronal tissue type from a subject or an animal that was subjected to at least one of a plurality of behavioral therapies and that has undergone a selected physiological change since commencement of the behavioral therapy comprises at least one microRNA profile from Table 1, Table 2, or a combination thereof.

### EXAMPLES

The invention now being generally described, it will be more readily understood by reference to the following examples, which are included merely for purposes of illustration of certain aspects and embodiments of the present invention, and are not intended to limit the invention, as one skilled in the art would recognize from the teachings hereinabove and the following examples, that other DNA microarrays, neurological conditions, cognitive therapies or data analysis methods, all without limitation, can be employed, without departing from the scope of the invention as claimed. The contents of any patents, patent applications, patent publications, or scientific articles referenced anywhere in this application are herein incorporated in their entirety.

### Example 1

Investigation of Post-Transcriptional Gene Regulatory Networks Associated with Autism Spectrum Disorders (ASD) by microRNA Expression Profiling of Lymphoblastoid Cell Lines

This example examines global miRNA expression profiling using lymphoblasts derived from these autistic twins and unaffected sibling controls was therefore performed using high-throughput miRNA microarray analysis. Differentially expressed miRNAs were found to target genes highly involved in neurological functions and disorders in addition to genes involved in gastrointestinal diseases, circadian rhythm signaling, as well as steroid hormone metabolism and receptor signaling. Novel network analyses of the relevant target genes further revealed an association to ASD and other co-morbid disorders, including muscle and gastrointestinal diseases, as well as to biological functions implicated in ASD, such as memory and synaptic plasticity. Findings from this study strongly suggest that dysregulation of miRNA expression contributes to the observed alterations in gene expression and, in turn, may lead to the pathophysiological conditions underlying autism.

### Materials and Methods

### Experimental Model and Cell Culture

LCL derived from peripheral lymphocytes of 14 male subjects were obtained from the Autism Genetic Resource Exchange (AGRE, Los Angeles, Calif.). The subjects included three pairs of monozygotic twins discordant for diagnosis of autism, a normal sibling for 2 of the twin pairs, two pairs of autistic and unaffected siblings, and a pair of normal monozygotic twins. These cell lines had all been used previously for gene expression profiling [16, 32] and thus allowed us to compare miRNA expression profiles with mRNA expression levels in the respective samples as well as across the affected and control samples. The frozen cells were cultured in L-Glutamine-added RPMI 1640 (Mediatech Inc., Herndon, Va.) with 15% triple-0.1 μm-filtered fetal bovine serum (Atlanta Biologicals, Lawrenceville, Ga.) and 1% penicillin-streptomycin-amphotericin (Mediatech).

According to the protocol from the Rutgers University Cell and DNA Repository (which contains the AGRE samples), cultures were split 1:2 every three to four days, and cells were harvested for miRNA isolation three days after a split, while the cell lines were in logarithmic growth phase. All cell lines were cultured and harvested at the same time with the same procedures and reagents to minimize the differences in miRNA expression that might occur as a result of different cell and miRNA preparations.

miRNA Isolation

LCLs were disrupted in TRIzol Reagent (Invitrogen, Carlsbad, Calif.) and miRNAs were then extracted from the TRIzol lysate using mirVana miRNA Isolation Kit (Ambion, Austin, Tex.) according to the manufacturers' protocols. Briefly, the lysates were subjected to Acid-Phenol:Chloroform extraction, which provides a robust front-end purification that also removes most DNA [33]. Ethanol (100%) was added to bring the samples to 25% ethanol and the mixture was then passed through the glass-fiber filter. Large RNAs were immobilized and small RNA species were collected in the filtrate. Ethanol was again added to the filtrate to increase the ethanol concentration to 55%, and the mixture was passed through the second glass-fiber filter where the small RNAs became immobilized. After washing a few times, the immobilized small RNAs were eluted in DNase-RNase-free water (Invitrogen), yielding an RNA fraction highly enriched in small RNA species (≦200 nt). The concentration of the small RNAs in the final fraction was then measured with a NanoDrop 1000 spectrophotometer (Thermo Fisher Scientific, Wilmington, Del.).

Reference miRNA Preparation

To enable comparison of miRNA expression patterns across all of the samples, equal amounts of miRNAs from unaffected siblings and normal control individuals were pooled to make a common reference miRNA that was co-hybridized with each sample on the miRNA microarray. The concentration of the reference miRNA was also quantitated with a NanoDrop 1000 spectrophotometer (Thermo Fisher Scientific). miRNA Microarray Analysis

Custom-printed miRNA microarrays were used to screen miRNA expression profiles of LCL from autistic and normal or undiagnosed individuals. The array slides were printed in the Microarray CORE Facility of the National Human Genome Research Institute (NHGR1, NIH, Bethesda, Md.). Briefly, mirVana miRNA Probe Set 1564V2, which is a collection of 662 amine-modified DNA oligonucleotides targeting a comprehensive selection of human, mouse, and rat miRNAs as well as internal control probes, were printed on Corning epoxide-coated slides (Corning Inc., Corning, N.Y.) in triplicate. miRNA microarray labeling and hybridization were performed using Ambion's miRNA Labeling Kit and Bioarray Essential Kit, respectively, according to the manufacturer's instructions. Briefly, a 20-50-nucleotide tail was added to the 3′ end of each miRNA in the sample using E. coli Poly (A) Polymerase. The amine-modified miRNAs were then purified and coupled to amine-reactive NHS-ester CyDye fluors (Amersham Biosciences, Piscataway, N.J.). A reference design was used for microarray hybridization in this study. The sample miRNAs were coupled with Cy3, whereas the common reference miRNA was coupled with Cy5, and two-colored miRNA microarray analyses were carried out by co-hybridizing an equal amount of both miRNA samples onto one slide.

After hybridization and washing, the microarrays were scanned with a ScanArray 5000 fluorescence scanner (PerkinElmer, Waltham, Mass.) and the raw pixel intensity images were analyzed using IPLab image processing software package (Scanalytics, Fairfax, Va.). The program performs statistical methods that have been previously described [34] to locate specific miRNAs on the array, measure local background for each of them, and subtract the respective background from the spot intensity value. Besides the background subtraction, the IPLab program was also used for within-array normalization and data filtering. Fluorescence ratios within the array were normalized according to a ratio distribution method at confidence level=99.00. The filtered data from the IPLab program were then uploaded into R version 2.6.1 software package to perform array normalization across all of the samples based upon quantile-quantile (Q-Q) plots, using a procedure known as quantile normalization [35].

Assessing Significance of miRNA Expression

To identify significantly differentially expressed miRNA, the normalized data were uploaded into the TMeV 3.1 software package [36, 37] to perform statistical analyses on the microarray data as well as cluster analyses of the differentially expressed genes. Pavlidis Template Matching (PTM) analyses [38] were carried out to identify significantly differentially expressed probes between autistic and control groups (p≦0.05), and Significance Analysis for Microarrays (SAM) was used in a two-class analysis (autistic vs. control) to further determine the false discovery rate associated with the differentially expressed miRNAs from the PTM analysis. Cluster analyses were performed with the significantly differentially expressed miRNAs using the hierarchical cluster (HCL) analysis program within TMeV, based on Euclidean distance using average linkage clustering methods. Principal component analysis (PCA) was further employed to reduce the dimensionality of the microarray data and display the overall separation of samples from autistic and control groups.

### Prediction of the Potential Target Genes

The lists of the potential target genes of the differentially expressed miRNAs were generated using miRBase (available at http://miRNA.sanger.ac.uk/) where the miRanda algorithm is used to scan all available mRNA sequences to search for maximal local complementarity alignment between the miRNA and the 3′ UTR sequences of putative predicted mRNA targets [39]. The benefit of using this program is that it also provides P-orthologous-group (P-org) values, which represent estimated probability values of the same miRNA family binding to multiple transcripts for different species in an orthologous group. The values are calculated from the level of sequence conservation between all of the 3′UTRs according to the statistical model previously described [40].

Only target sites for which the P-org value was less than 0.05 were included to minimize false positive predictions.

### Preliminary Functional Analyses of the Potential Target Genes

Ingenuity Pathway Analysis (IPA) version 6.0 (Ingenuity Systems, www.ingenuity.com) and Pathway Studio version 5 (Ariadne Genomics, www.ariadnegenomics.com) network prediction software was used to identify gene networks, biological functions, and canonical pathways that might be impacted by dysregulation of the differentially expressed miRNAs, using the lists of predicted target genes of each differentially expressed miRNA to interrogate the gene databases. The Fisher Exact test was used to identify significant pathways and functions associated with the gene datasets. miRNA TaqMan qRT-PCR analysis

Among the differentially expressed miRNAs, four brain-specific or brain-related miRNAs (hsa-miR-219, hsa-miR-29, hsa-miR-139-5p, and hsa-miR-103) were selected for confirmation analysis by miRNA TaqMan quantitative reverse transcription-PCR (qRT-PCR) assays (Applied Biosystems, Foster City, Calif.). Small nucleolar RNA, C/D box 24 (RNU24) was used as an endogenous control in all qRT-PCR experiments. According to the Applied Biosystems TaqMan MicroRNA Assay protocol, cDNA was reverse transcribed from 10 ng of total RNA samples using specific looped miRNA RT primers, which allow for specific RT reactions for mature miRNAs only. The cDNA was then amplified by PCR, which uses TaqMan minor groove binder (MGB) probes containing a reporter dye (FAM dye) linked to the 5′ end of the probe, a minor groove binder at the 3′ end of the probe, and a non-fluorescence quencher (NFQ) at the 3′ end of the probe. The design of these probes allows for more accurate measurement of reporter dye contributions than possible with conventional fluorescence quenchers.

### Meta-Analysis of Gene Expression Data

A meta-analysis was performed to correlate differential miRNA expression with gene expression data that had previously been obtained by our laboratory using the same samples. However, the expression data were reanalyzed because the twin study [16] and that involving affected-unaffected sib pairs [32] were performed using a different experimental design (direct sample comparison for the twin study and a reference design with Stratagene universal human reference RNA for the sib-pair analysis). For consistency, the log₂ ratios of gene expression for the autistic sibling relative to his respective unaffected sibling (either the undiagnosed co-twin or normal sibling) were calculated from the raw data obtained from the sib-pair study and used for further statistical analyses. Data filtration was performed using TMeV version 3.1 software [36] to extract only genes for which expression values were present in at least four out of seven comparisons. The filtered data were then uploaded into the R statistical software package (www.R-project.org) [41] to carry out quantile normalization. After global data distribution, standard deviation and mean values of all paired samples were normalized to the same level to enable comparison of gene expression data against the entire set of the samples, the normalized data were imported into the TMeV program again to perform statistical analyses. A one-class t-test analysis was conducted across all samples, and significantly differentially expressed genes were identified as those with p-values <0.05. Correlation between the Expression of the Target Genes and the Candidate miRNAs

To identify the differentially expressed genes potentially regulated by the differentially expressed miRNAs in autistic individuals, the overlapping genes between the significant gene list from the one-class t-test (p<0.05) and the list of the potential target genes of the differentially regulated miRNAs were identified. A relatively stringent expression level cutoff of log₂(ratio)>±0.4 was used inasmuch as we are typically able to confirm genes with a log₂(ratio)>±0.3 by qRT-PCR. Only the target genes that were expressed in the opposite direction from that of the pertinent miRNAs were extracted for functional analyses. Although miRNA often acts as a translational repressor in mammalian cells, the targeted mRNA species is often delivered to P-bodies where it is eventually degraded [42]. Thus, we decided to perform pathway analyses only on those genes whose mRNA changes were directionally opposite to the change in miRNA expression, while acknowledging that other mRNA species may also be potential targets of the differentially expressed miRNA.

### Identification of Biological Functions Disrupted by Dysregulated Target Genes

To gain insight into biological functions that may be disrupted in ASD as a consequence of altered miRNA expression, the differentially expressed genes whose transcript levels were inversely correlated with that of the differentially expressed miRNAs were uploaded into IPA and Pathway Studio network prediction programs and the target gene networks were generated. Significant biological functions, canonical pathways, and diseases highly represented in the networks were identified using Fisher's Exact test (p<0.05).

### Transfection of Pre-miR5 and Anti-miR5

All transfections were performed using siPORT NeoFX Transfection Agent (Applied Biosystems) according to the manufacturer's protocol. Briefly, LCLs were counted and diluted into 2×10⁵ cells/2.3 ml and incubated at 37° C. A total of 5 ul siPORT NeoFX Transfection Agent per transfection condition was diluted and incubated for 10 min at room temperature with 95 ul of the prewarmed complete growth media (without antibiotics). Hsa-miR-29b Pre-miR Precursor, hsa-miR-219b Anti-miR Inhibitor, Cy3-labeled Pre-miR Negative Control and the Cy3-labeled Anti-miR Negative Control (Applied Biosystems) were diluted into the media to a final small RNA concentration of 30 nM in 100 ul of the complete growth media. Cell suspensions were overlaid onto the transfection solution and mixed gently before incubation at 37° C. with 5% CO₂ for 72 hours. Following incubation, the cells were harvested for subsequent analyses.

### Results

Significantly Differentially Expressed miRNAs

To identify significantly differentially expressed miRNAs, normalized miRNA microarray data were uploaded into the TMeV program for statistical analysis. Pavlidis Template Matching (PTM) analysis revealed 49 human miRNAs that were significantly differentially dysregulated (p<0.05) in autistic individuals. The false discovery rate (FDR) for this set of genes was determined using the Significance Analysis of Microarrays (SAM) program, and 48 out of 49 human probes were identified as significantly differentially expressed (FDR<0.001%). These miRNAs and their corresponding log₂ ratios and respective p-values are shown in Table 1.

### Cluster and Principal Component Analysis of the Significant Probes

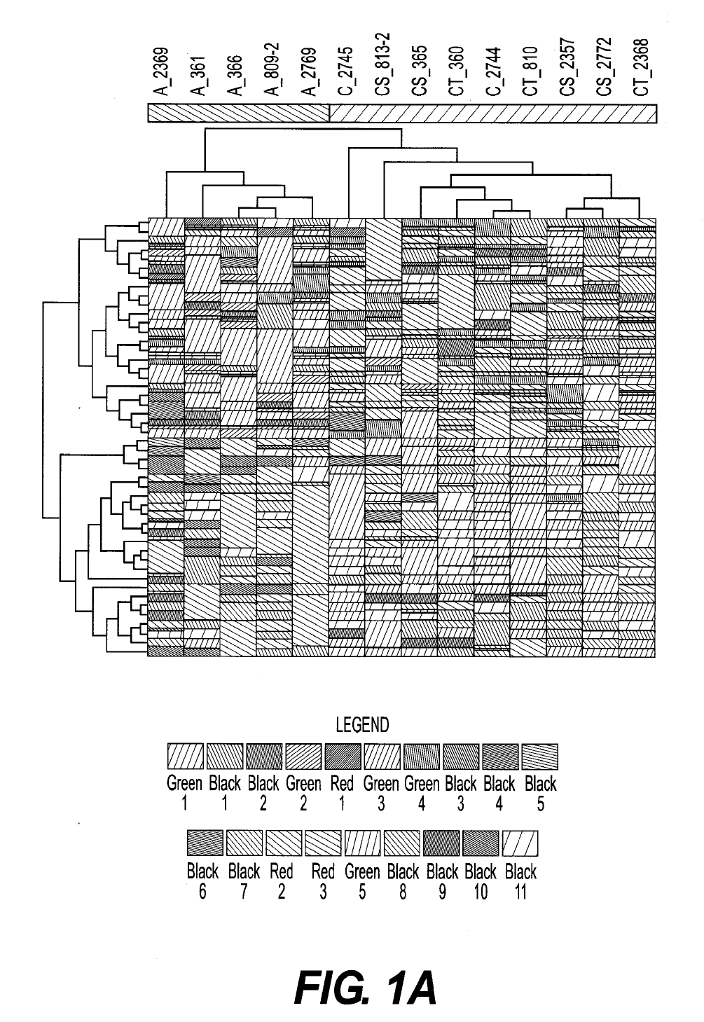

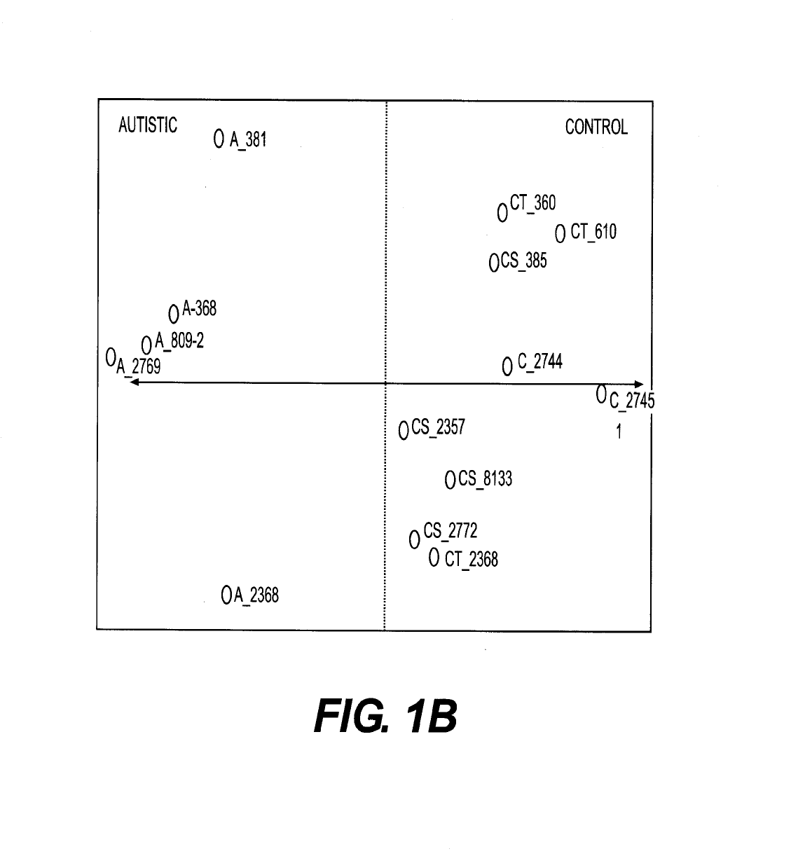

Cluster analyses were performed with the significantly differentially expressed miRNAs from the combined PTM-SAM analyses to determine whether or not the expression levels of these miRNAs could distinguish between the autistic and control groups. Both unsupervised, hierarchical cluster analysis (FIG. 1A) and supervised, 2-cluster K-means analysis (data not shown) revealed complete separation of the autistic and control groups based on expression profile of the differentially expressed miRNAs. Principal component analysis (PCA; FIG. 1B), which was employed to reduce the dimensionality of the microarray data, also revealed clear separation between autistic individuals and controls based on the 48 significant probes.

Biological Network Prediction of the Potential Targets Revealed a Strong Association with Neurological Functions and Other Biological Pathways Involved in ASD

Potential target genes for each of the differentially expressed miRNAs were identified using miRBase Targets software (http://microrna.sanger.ac.uk/targets/v5/). To further identify the biological networks and functions in which these target genes are involved, the target gene list for each miRNA was analyzed using IPA (Table 2). Interestingly, the target genes of 35 out of the 48 human miRNA probes (more than 70% of the significantly differentially expressed miRNAs) were found to be significantly associated with “neurological functions” or “nervous system development and function” (Fisher's Exact test, p<0.05).

In addition to gene targets associated with neurological functions, it is noteworthy that a number of the differentially expressed miRNAs also target genes involved in co-morbid disorders associated with ASD, such as muscular and gastrointestinal diseases [43-51]. Target genes of 13 miRNAs (29%) significantly dysregulated in autistic probands were associated with skeletal and muscular diseases or skeletal and muscular development and function. Target genes for 12 significantly dysregulated miRNAs (25%) were associated with gastrointestinal disorders or gastrointestinal development and function, as well as hepatic system disease, hepatic fibrosis, and hepatic cholestasis (p<0.05). It is interesting to note that these disorders are among the most significant biological functions and pathways enriched within the dataset of target genes, inasmuch as ASD individuals are frequently found to have co-morbid diagnoses involving muscle dysfunction (e.g. muscular dystrophy, muscle weakness, and hypotonia) and digestive disorders that affect absorption and metabolism.

Another interesting biological function associated with the miRNA gene targets is steroid hormone metabolism. More than 10% (5 out of 48) of the differentially expressed miRNAs showed an association with androgen and estrogen metabolism, as well as estrogen receptor signaling (p<0.05). Moreover, IPA also showed that target genes for two of the most significantly up-regulated miRNAs—hsa-miR-376a and hsa-miR-29b—were significantly associated with circadian rhythm signaling (Fisher's Exact test, p=4.71E-03 and 1.63E-03, respectively).

Quantitative TaqMan RT-PCR Confirmation of Selected miRNAs

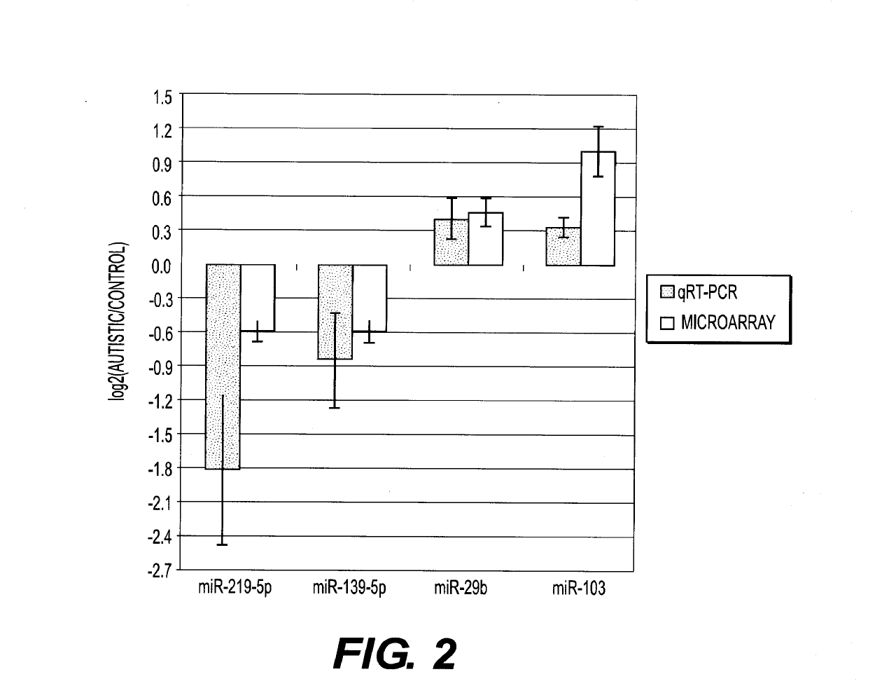

MicroRNA TaqMan quantitative RT-PCR (qRT-PCR) analyses were performed to confirm the miRNA expression data of four miRNAs known to be associated with brain development and function. Hsa-miR-29b and hsa-miR-219 are known to be brain-specific, while hsa-miR-139-5p is highly enriched in brain [52-54]. Although not specific to the brain, hsa-miR-103 is highly expressed during brain development [52, 55], suggesting an important role in brain development and function. Expression levels of all four brain-associated miRNAs from these analyses were correlated with miRNA microarray data (FIG. 2).

Correspondence Between Differentially Expressed Putative Target Genes and the Differentially Regulated miRNAs

To examine the possibility that changes in specific miRNAs could result in corresponding changes in the expression levels of the putative target genes, differentially expressed genes from previous miRNA microarray analyses of the same LCLs used in this study [16, 32] were compared with the potential target genes of the differentially expressed miRNAs. Of the 3,905 differentially expressed genes between the autistic and control groups, 1,406 (36%) were found to be putative targets of the differentially expressed miRNA, with 1,053 of these genes exhibiting changes inversely correlated with the respective miRNA changes. Although translational repression is the main mechanism of suppression by miRNA in mammalian cells, the suppressed target mRNA often eventually degrades in P-bodies [42], thus leading to the expected decreases in transcript levels observed here.

To increase the stringency of the pathway analyses, an expression level cutoff of log₂(ratio)≧±0.4 was applied that reduced the list of potential gene targets to 94 genes (Table 3). IPA analysis of this set of genes revealed a number of genes significantly involved in neurological disease (p=1.38E-03−1.89E-02). Inflammatory diseases, which have also been associated with ASD [17], were found to be significantly associated with the differentially expressed potential target genes (p=2.51E-03−2.11E-02). It is interesting to note that lipid metabolism is a cellular function that is a potential target of miRNA regulation. The top canonical pathways implicated by the target genes were nitric oxide signaling (p=1.07E-02), vascular endothelial growth factor (VEGF) signaling (p=1.47E-02), and amyotrophic lateral sclerosis signaling (ALS) (p=1.88E-02).

Network Prediction of the Differentially Expressed Potential Target Genes of the Differentially Expressed miRNAs in ASD

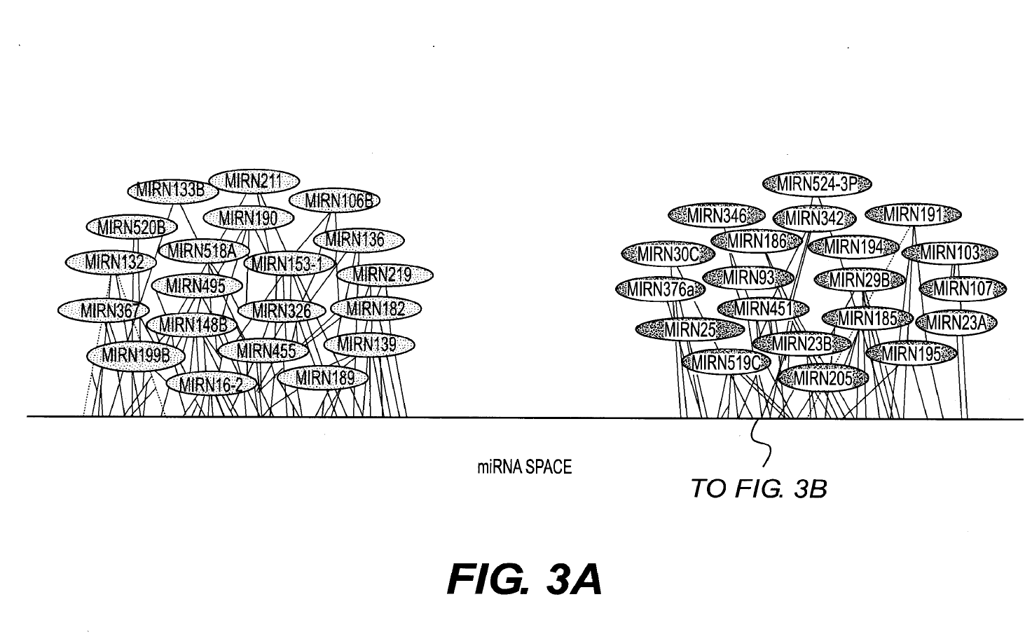

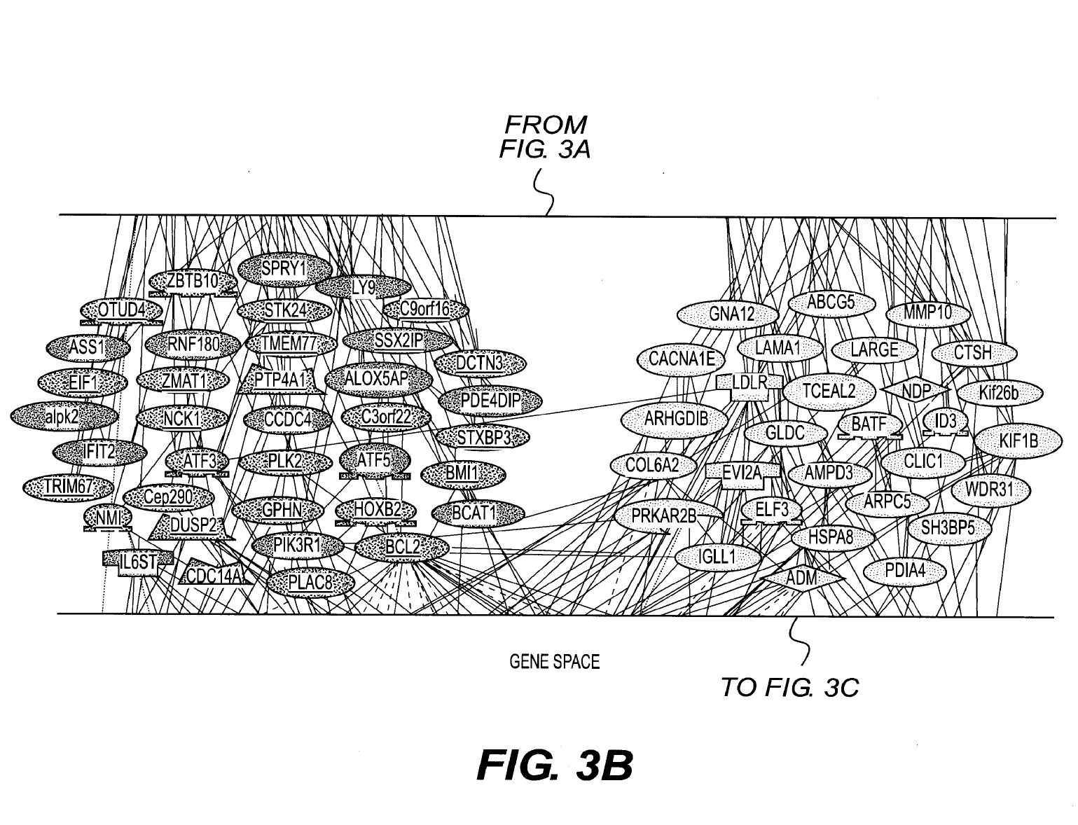

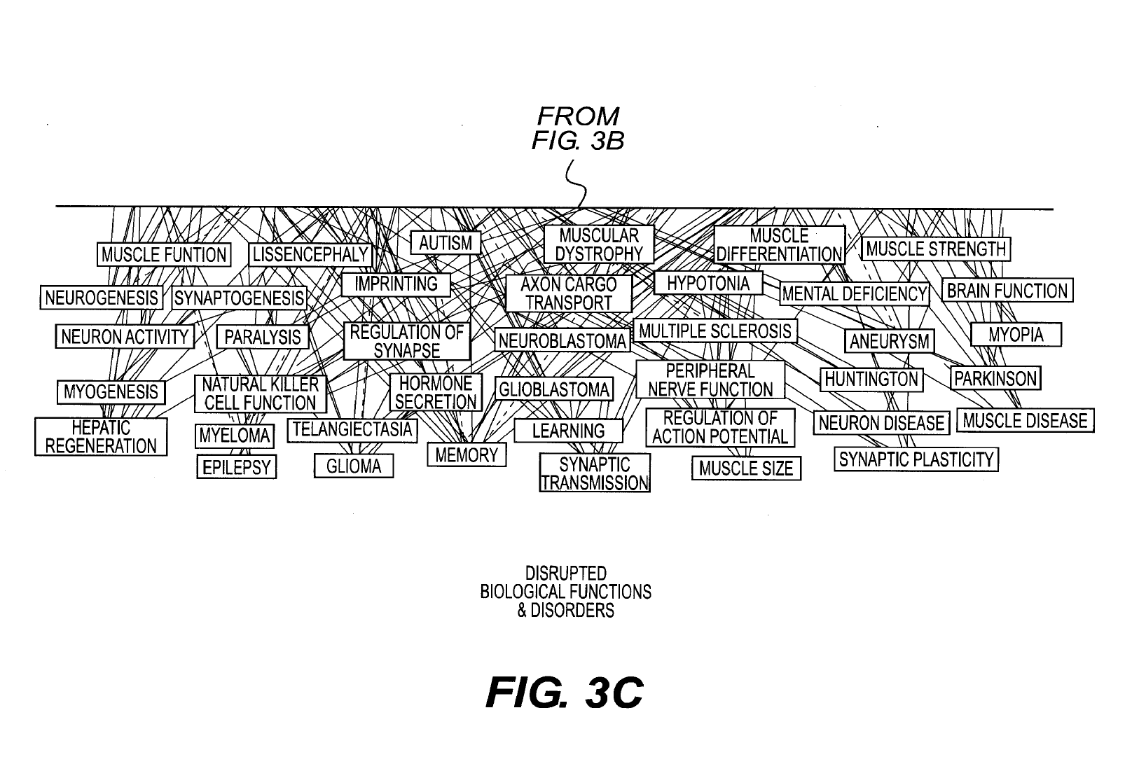

The differentially expressed potential miRNA targets were analyzed with Pathway Studio 5 to identify the possible relationships among the target genes and their associated functions (FIG. 3). Interestingly, the pathway generated by Pathway Studio revealed relationships between the potential targets of the miRNAs and autism, as well as other neurological functions and disorders previously found to be impacted or associated with ASD, such as memory, regulation of synapses, synaptic plasticity, muscle disease, muscular dystrophy, and muscle strength [43, 44, 56].

Validation of miRNA Targets

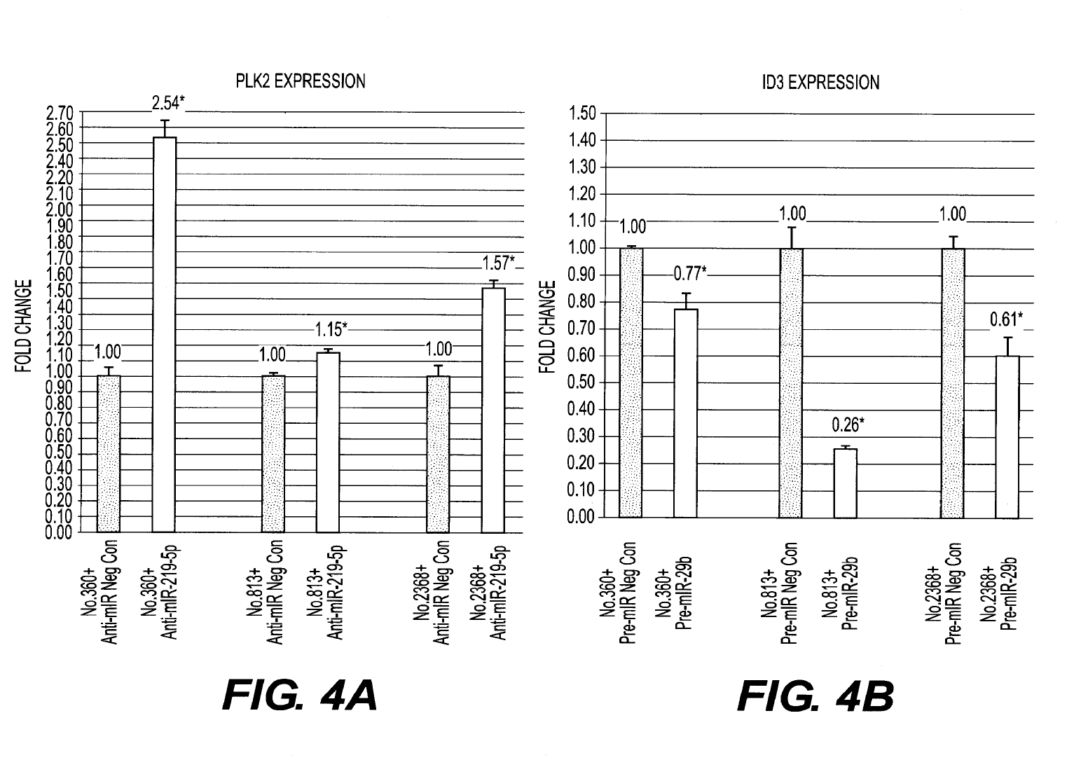

Two brain-specific miRNAs (hsa-miR-29b and hsa-miR-2,9-5p), whose differential expression in ASD was confirmed by TaqMan miRNA qRT-PCR analyses, were selected for miRNA target validation. Among putative target genes of these miRNAs, a gene coding for Inhibitor of DNA binding 3 (ID3) was significantly down-regulated, exhibiting inverse correlation with hsa-miR-29b overexpression in ASD individuals, whereas polo-like kinase 2 (PLK2) was significantly up-regulated, showing inverse correlation with hsa-miR-2,9-5p down-regulation. ID3 and PLK2 have been associated with circadian rhythm signaling and modulation of synapses [57-60], respectively, and both biological mechanisms have been implicated in ASD [12-15, 61-68]. To examine whether the overexpression of hsa-miR-29b and the suppression of hsa-miR-2,9-5p as observed in autistic individuals could alter ID3 and PLK2 transcript levels, LCLs derived from 3 nonautistic individuals were transfected with hsa-miR-29b Pre-miR Precursor and hsa-miR-219b Anti-miR Inhibitor respectively to increase hsa-miR-29b and decrease hsa-miR-2,9-5p activity in the cells. Quantitative RT-PCR analyses of the transfected cells revealed the down-regulation of ID3 gene in the LCLs transfected with hsa-miR-29b Pre-miR Precursor, and the up-regulation of PLK2 gene in the LCLs transfected with hsa-miR-219b Anti-miR Inhibitors (FIG. 4). These results indicate that overexpression of hsa-miR-29b and suppression of hsa-miR-2,9-5p can lead to decreased ID3 and increased PLK2 levels, respectively.

The miRNA expression profiling study of LCLs derived from individuals with ASD, their discordant monozygotic co-twins, and/or their unaffected siblings revealed a set of significantly differentially expressed miRNAs whose target genes were associated with neurological diseases and functions. The significant differential expression of brain-specific and brain-related miRNAs detected in LCLs reflected systemic changes underpinning ASD that gave rise to neuropathological conditions and, moreover, support the use of LCL as a surrogate tissue to study miRNA expression in ASD.

### List of Abbreviations

### AANAT Arylalkylamine-N-acetyltransferase

ADHD Attention-deficit hyperactivity disorder

### AGRE The Autism Genetic Resource Exchange

ALS Amyotrophic lateral sclerosis
Anti-miR Anti-miR miRNA Inhibitor
ARNTL Aryl hydrocarbon receptor nuclear translocator-like
ARPC5 Actin related protein ⅔ complex, subunit 5, 16 kDa

### ASD Autism Spectrum Disorder

ATF2 Activating transcription factor 2
BHLBH2 Class B basic helix-loop-helix protein 2
BM Bethlem myopathy
BMAL1 Brain and muscle ARNT-like 1
CDK5 Cyclin-dependent kinase 5
CDK5RAP2 CDK5 regulatory subunit associated protein 2
CLIC1 Chloride intracellular channel 1
CLOCK Clock homolog
CMT Charcot-Marie-Tooth disease

### CNN Centrosomin

CNS Central nervous system
CNTNAP2 Contactin associated protein-like 2

### CoA Coenzyme A

COL6A2 Collagen, type VI, alpha 2
CRY1 Cryptochrome 1 (photolyase-like)
DPYD Dihydropyrimidine dehydrogenase
DUSP2 Dual specificity phosphatase 2
FDR False discovery rate
FMRP Fragile X mental retardation protein
HCL Hierarchical clustering
ID3 Inhibitor of DNA binding 3

### IL6 Interleukin 6

### IPA The Ingenuity Pathway Analysis

KIF1B Kinesin family member 1B
KIF26b Kinesin family member 26B
LCL Lymphoblastoid cell line

### MCPH Microcephalin

MeCP2 Methyl CpG binding protein 2
MGB Minor groove binder
miRNA microRNA
NFQ Non-fluorescence quencher

### NLGN Neuroligin

### NLGN3 Neuroligin 3

### NLGN4 Neuroligin 4

NMDA N-methyl-D-aspartic acid
NPAS2 Neuronal PAS domain protein 2

### NRXN1 Neurexin 1

PANK Pantothenate kinase
PCA Principal components analysis
PDE4DIP Phosphodiesterase 4D interacting protein
PER1 Period homolog 1
PER3 Period homolog 3
PLK2 Polo-like kinase 2
P-org P-orthologous value
Pre-miR Pre-miR miRNA Precursor

### PTM Pavlidis Template Matching

qRT-PCR Quantitative reverse transcription-polymerase chain reaction

### SAM Significance Analysis of Microarrays

SHANK3 SH3 and multiple ankyrin repeat domains 3
SPAR Spine-associated Rap GTPase-activating protein

### TMeV The TIGR Multiexperiment Viewer

UCMD Ullrich congenital muscular dystrophy
VEGF Vascular endothelial growth factor
VIP Vasoactive intestinal peptide

TABLE 1
Significantly Differentially Expressed Human miRNAs from PTM-SAM
Analysis. Forty-eight significantly differentially expressed human miRNA probes were
identified by the PTM analysis (p < 0.05), followed by two-class SAM between the ASD
and control groups (% FDR < 0.001). The log₂ ratios for all miRNAs were calculated from
the average of the log₂ ratio across all autistic samples over the average of the log₂ ratio
across all control samples.

| Down-regulated | log₂ | | Up-regulated | log₂ | |
|---|---|---|---|---|---|
| miRNAs | (Aₐᵥₑ/Cₐᵥₑ) | p-value | miRNAs | (Aₐᵥₑ/Cₐᵥₑ) | p-value |
| hsa-miR-182 | −1.54 | 1.44E−03 | hsa-miR-185 | 1.44 | 4.04E−03 |
| hsa-miR-136 | −1.50 | 2.28E−03 | hsa-miR-103 | 1.31 | 1.20E−02 |
| hsa-miR-518a | −1.45 | 3.52E−03 | hsa-miR-107 | 1.26 | 1.68E−02 |
| ACA41_47 | −1.43 | 4.35E−03 | hsa-miR-29b | 1.24 | 1.88E−02 |
| hsa-miR-153-1 | −1.41 | 5.07E−03 | hsa-miR-194 | 1.22 | 2.11E−02 |
| hsa-miR-520b | −1.38 | 6.71E−03 | hsa-miR-524 | 1.22 | 2.21E−02 |
| hsa-miR-455 | −1.30 | 1.25E−02 | hsa-miR-191 | 1.21 | 2.23E−02 |
| hsa-miR-326 | −1.24 | 1.95E−02 | hsa-miR-376a | 1.19 | 2.53E−02 |
| hsa-miR-199b | −1.23 | 1.96E−02 | hsa-miR-451 | 1.19 | 2.64E−02 |
| hsa-miR-211 | −1.23 | 2.04E−02 | hsa-miR-23b | 1.17 | 2.95E−02 |
| hsa-miR-132 | −1.22 | 2.20E−02 | hsa-miR-195 | 1.16 | 3.02E−02 |
| hsa-miR-495 | −1.20 | 2.43E−02 | hsa-miR-23b | 1.16 | 3.03E−02 |
| hsa-miR-16-2 | −1.19 | 2.54E−02 | hsa-miR-342 | 1.15 | 3.24E−02 |
| hsa-miR-190 | −1.18 | 2.69E−02 | hsa-miR-23a | 1.14 | 3.36E−02 |
| hsa-miR-219 | −1.17 | 2.98E−02 | hsa-miR-186 | 1.14 | 3.43E−02 |
| hsa-miR-148b | −1.16 | 3.01E−02 | hsa-miR-25 | 1.14 | 3.55E−02 |
| hsa-miR-189 | −1.16 | 3.06E−02 | ACA30_14 | 1.13 | 3.61E−02 |
| hsa-miR-133b | −1.13 | 3.59E−02 | hsa-miR-519c | 1.13 | 3.71E−02 |
| HBII-85_groupII_14_5 | −1.13 | 3.63E−02 | hsa-miR-346 | 1.12 | 3.80E−02 |
| mgh28S-2410_0 | −1.12 | 3.91E−02 | hsa-miR-205 | 1.12 | 3.80E−02 |
| hsa-miR-106b | −1.11 | 4.11E−02 | hsa-miR-30c | 1.11 | 3.98E−02 |
| hsa-miR-367 | −1.10 | 4.21E−02 | U29_0 | 1.11 | 4.08E−02 |
| hsa-miR-139 | −1.10 | 4.32E−02 | hsa-miR-93 | 1.10 | 4.18E−02 |
| ACA25_44 | −1.10 | 4.37E−02 | hsa-miR-186 | 1.08 | 4.67E−02 |

TABLE 2
IPA Biological Functions and Pathways Associated with Potential Targets for
Significantly Differentially Expressed miRNAs. IPA analysis of potential target genes for
each of the significantly differentially expressed miRNAs revealed biological functions
and pathways associated with the target genes. P-values calculated from Fisher's Exact
test for each function are listed in the parenthesis; the number of genes involved in each
biological function or pathway is listed in the square brackets.

| miRNA | Biological Functions/Pathways of the miRNA Targets (p-value) [#Genes]* |
|---|---|
| hsa-miR-182 | N (1.18E−03-3.86E−02)[59], E (1.49E−03-3.70E−02)[14] |
| hsa-mir-136 | G (1.60E−04-3.46E−02)[10], A (6.33E−03)[8], E (3.50E−03-3.46E−02)[21] |
| hsa-miR-518a | N (7.24E−03-4.89E−02)[50], E (8.57E−05-4.44E−02)[20] |
| hsa-mir-153-1 | N (1.02E−05-2.24E−02)[28], G (6.37E−04-1.53E−02)[13] |
| hsa-miR-520b | N (2.66E−03-4.44E−02)[15], E (8.13E−04-4.44E−02)[28] |
| hsa-miR-455 | N (2.03E−03-4.51E−02)[83], E (1.06E−03-4.51E−02)[42] |
| hsa-miR-326 | S (6.24E−04-3.99E−02)[28] |
| hsa-miR-199b | N (8.24E−04-4.23E−02)[31], E (6.04E−03-4.23E−02)[21], S (5.23E−03-4.23E−02)[11] |
| hsa-miR-211 | N (7.78E−05-2.99E−02)[15], I (6.23E−04-2.99E−02)[19] |
| hsa-mir-132 | N (2.01E−03-4.48E−02)[19], G (2.01E−03-4.48E−02)[23], E (2.01E−03-4.48E−02)[28] |
| hsa-miR-495 | N (6.09E−04-4.02E−02)[48], G (1.62E−03-4.02E−02)[10], E (2.51E−04-4.02E−02)[24] |
| hsa-mir-16-2 | N (8.75E−05-4.45E−02)[13], E (1.06E−03-4.45E−02)[24], S (1.58E−03-4.45E−02)[17], Es |
| | (4.86E−02)[9] |
| hsa-miR-190 | N (6.63E−04-3.86E−02)[39], G (2.15E−03-3.86E−02)[12], E (3.83E−04-4.15E−02)[25] |
| hsa-miR-219 | N (1.08E−03-4.34E−02)[87], E (1.88E−03-4.34E−02)[11] |
| hsa-miR-148b | N (6.54E−04-4.63E−02)[27], G (3.81E−04-4.63E−02)[27] |
| hsa-miR-189 | N (1.57E−03-3.76E−02)[23}, E (1.57E−03-3.76E−02)[19] |
| hsa-miR-133b | E (7.84E−04-2.56E−02)[17] |
| hsa-mir-106b | N (1.37E−03-4.41E−02)[21], G (1.01E−02-4.23E−02)[33], I (1.54E−03-4.38E−02)[18] |
| hsa-miR-367 | N (1.35E−03-4.37E−02)[20], G (1.33E−03-4.37E−02)[11] |
| hsa-miR-139 | G (1.37E−03-4.02E−02)[19], E (1.61E−03-4.02E−02)[21] |
| hsa-miR-186 | N (9.62E−04-3.11E−02)[27], E (2.83E−03-3.11E−02)[14], S (9.62E−04-3.11E−02)[17], Es |
| | (1.82E−02)[8] |
| hsa-mir-93 | N (2.67E−04-4.33E−02)[36], I (4.47E−04-4.33E−02)[35] |
| hsa-miR-30c | N (9.85E−05-4.21E−02)[40], E (3.31E−04-4.21E−02)[25] |
| hsa-miR-205 | N (1.40E−03-3.75E−02)[9], S (1.19E−04-3.75E−02)[23] |
| hsa-miR-346 | I (8.61E−04-3.03E−02)[56] |
| hsa-miR-519c | G (7.42E−04-4.76E−02)[81], N (6.58E−03-4.71E−02)[25] |
| hsa-miR-25 | N (1.04E−04-3.61E−02)[39], Es (3.95E−02)[8] |
| hsa-mir-186 | N (9.62E−04-3.11E−02)[27], E (2.83E−03-3.11E−02)[14], S (9.62E−04-3.11E−02)[17], Es |
| | (1.82E−02)[8] |
| hsa-miR-23a | N (1.69E−03-4.11E−02)[81], S (8.70E−04-4.11E−02)[62] |
| hsa-miR-342 | N (6.49E−04-4.11E−02)[15], E (2.13E−03-4.11E−02)[12], S (6.49E−04-4.11E−02)[15] |
| hsa-miR-23b | N (4.31E−05-4.01E−02)[87], S (3.71E−03-4.01E−02)[60], E (4.68E−03-4.01E−02)[20] |
| hsa-miR-195 | N (4.59E−03-4.04E−02)[74], Es (1.12E−02)[10] |
| hsa-miR-23b | N (4.31E−05-4.01E−02)[87], S (3.71E−03-4.01E−02)[60], E (4.68E−03-4.01E−02)[20] |
| hsa-miR-451 | S (2.99E−04-2.43E−02)[29] |
| hsa-miR-376a | N (1.62E−03-3.88E−02)[23], E (1.62E−03-3.10E−02)[10], S (1.17E−04-4.02E−02)[32], C |
| | (4.71E−03)[5] |
| hsa-miR-191 | N (2.53E−04-4.62E−02)[34], E (1.87E−03-3.93E−02)[12] |
| hsa-miR-524- | N (3.44E−04-4.47E−02)[66] |
| 3p | |
| hsa-miR-194 | N (8.47E−03-3.86E−02)[24] |
| hsa-miR-29b | S (1.97E−05-2.91E−02)[41], C (1.63E−03)[6] |
| hsa-miR-107 | G (4.81E−04-4.13E−02)[46], E (1.27E−03-4.13E−02), N (1.70E−03-4.13E−02)[16] |
| hsa-miR-103 | G (1.31E−03-4.27E−02)[49], E (2.01E−04-4.27E−02), S (3.03E−03-4.27E−02)[23], N (1.82E−03-4.27E−2) |
| | [35] |
| hsa-miR-185 | N (8.16E−04-3.75E−02)[26] |

(The functions are described as: A = androgen and estrogen metabolism; C = circadian rhythm signaling; E = embryonic development; Es = estrogen receptor signaling; G = gastrointestinal diseases/digestive system development and functions; I = inflammatory diseases; N = neurological diseases/nervous system development and functions; S = skeletal and muscular disorders/skeletal and muscular system development and functions)

TABLE 3
Predicted Biological Functions from Ingenuity Pathways Analysis (IPA). IPA of
significant disorders, molecular and cellular functions, canonical pathways, and toxicity
genes that are strongly associated with 94 differentially expressed potential target genes
of the miRNAs (log₂ ratio ≧ ±0.4). The Fisher's Exact p-values and the number of genes
for each top biological function are listed.

| Diseases and Disorders | p-value | #Genes | Genes |
|---|---|---|---|
| Neurological Disease | 1.38E−03-1.89E−02 | 8 | UCHL1, ATF3, NDP, TUBB2C, |
| | | | KIF1B, TUBB2A, MST1, BCL2 |
| Inflammatory Disease | 2.51E−03-2.11E−02 | 16 | IL6ST, ADM, TUBB2C, IL32, |
| | | | PIK3R1, TUBB2A, EIF1, ALOX5AP, |
| | | | MMP10, DUSP2, BCL2, GNAI2, |
| | | | HSPA8, FUT8, LDLR, AHNAK |
| Skeletal and Muscular Disorders | 2.71E−03-1.89E−02 | 16 | IL6ST, ADM, COL6A2, TUBB2C, |
| | | | IL32, TUBB2A, ALOX5AP, MMP10, |
| | | | LARGE, DUSP2, BCL2, GNAI2, |
| | | | HSPA8, CEP290, BMI1, AHNAK |

Molecular and Cellular Functions

| | | | |
|---|---|---|---|
| Lipid Metabolism | 1.19E−04-2.51E−02 | 13 | ADM, IL6ST, ABCG5, ABHD5, |
| | | | IL32, PIK3R1, ALOX5AP, BCL2, |
| | | | GNAI2, IFRD1, LDLR, PRKAR2B, |
| | | | PITPNC1 |
| Molecular Transport | 1.19E−04-2.51E−02 | 12 | IL6ST, IFRD1, HSPA8, GNAI2, |
| | | | ABHD5, ABCG5, LDLR, PIK3R1, |
| | | | IL32, PITPNC1, ALOX5AP, BCL2 |
| Small Molecule Biochemistry | 1.19E−04-2.51E−02 | 17 | IL6ST, ADM, AMPD3, ABCG5, |
| | | | ABHD5, PIK3R1, ASS1, IL32, |
| | | | ALOX5AP, BCL2, IFRD1, GNAI2, |
| | | | BCAT1, LDLR, PITPNC1, GOT1, |
| | | | GLDC |
| Cellular Development | 1.32E−04-2.42E−02 | 13 | IL6ST, ATF3, PIK3R1, ID3, BCL2, |
| | | | IGLL1, IFRD1, ELF3, BMI1, |
| | | | PRKAR2B, PLK2, LAMA1, PLAC8 |
| Cell Death | 2.36E−04-1.89E−02 | 14 | IL6ST, ADM, ATF3, DDIT4, |
| | | | PIK3R1, NCK1, PSIP1, SH3BP5, ID3, |
| | | | BCL2, PRKAR2B, BMI1, PLK2, |
| | | | PLAC8 |

Canonical Pathways

| | | | |
|---|---|---|---|
| Nitric Oxide Signaling | 1.07E−02 | 3/90 | CACNA1E, PRKAR2B, PIK3R1 |
| VEGF Signaling | 1.47E−02 | 3/92 | PIK3R1, EIF1, BCL2 |
| Amyotrophic Lateral Sclerosis | 1.88E−02 | 3/108 | CACNA1E, PIK3R1, BCL2 |
| Signaling | | | |

Toxicity List

| | | | |
|---|---|---|---|
| Hormone Receptor Regulated | 4.96E−02 | 1/8 | LDLR |
| Cholesterol Metabolism | | | |

1. A microRNA chip array having a plurality of oligonucleotides, each with specificity for a microRNAs associated with at least one autism spectrum disorder, wherein the autism spectrum disorder comprises autistic disorder, pervasive developmental disorder—not otherwise specified (PDD-NOS), including atypical autism, Asperger's Disorder, or a combination thereof.

2. A microRNA chip array according to claim 1, wherein the oligonucleotides are specific for at least a subset of the microRNAs in Table 1, Table 2, or a combination thereof.

3. A method of screening a subject for a neurological disorder, comprising the steps of: (a) isolating a sample of nucleic acid, protein or cellular extract from at least one cell from the subject; (b) measuring gene expression levels of at least five different microRNAs selected from Table 1, Table 2, or a combination thereof in the sample, and comparing said expression levels with expression levels expected to be present in an individual who does not have the disease or disorder.

4. The method of claim 3, further comprising the step of determining whether a statistically-significant difference exists in expression levels of at least one gene listed in Table 3 and the expression levels of said at least five different microRNAs.

5. The method of claim 3, wherein the neurological disease is selected from autism spectrum disorder, autistic disorder, pervasive developmental disorder-not otherwise specified (PDD-NOS) including atypical autism, Asperger's Disorder, or a combination thereof.

6. The method of claim 3, wherein the at least 5 different microRNAs in Table 1, Table 2, or a combination thereof comprise microRNAs that target genes associated with nervous system development, axon guidance, synaptic transmission or plasticity, myelination, long-term potentiation, neuron toxicity, embryonic development, regulation of actin networks, digestion, inflammation, oxidative stress, epilepsy, apoptosis, cell survival, differentiation, the unfolded protein response, Type II diabetes and insulin signaling, digestion, liver toxicity (hepatic stellate cell activation, fibrosis, and cholestasis), endocrine function, circadian rhythm, cholesterol metabolism and the steroidogenesis pathway, or a combination thereof.

7. The method of claim 3, wherein the individual who does not have the disorder is a non-phenotypic discordant twin, sibling of the subject, or unrelated subject.

8. The method of claim 4, wherein the method distinguishes between different variants of autism spectrum disorder comprising a lower severity scores across all ADIR items, an intermediate severity across all ADIR items, a higher severity scores on spoken language items on the ADIR, a higher frequency of savant skills, and a severe language impairment, or a combination thereof.

9. The method of claim 3, wherein the microRNA expression levels are quantified with an assay comprising large scale microarray analysis, RT qPCR analysis, quantitative nuclease protection assay (qNPA) analysis, and focused gene chip analysis, in vitro transcription, Northern hybridization, nucleic acid hybridization, reverse transcription-polymerase chain reaction (RT-PCR), run-on transcription, Southern hybridization, electrophoretic mobility shift assay (EMSA), radioimmunoassay (RIA), fluorescent or histochemical staining, microscopy and digital image analysis, and fluorescence activated cell analysis or sorting (FACS), nucleic acid hybridization, antibody binding, or a combination thereof.

10. A method for determining a microRNA profile for at least one autism spectrum disorder, comprising (a) preparing samples of control and experimental microRNA, wherein the experimental microRNA is generated from a nucleic acid sample isolated from a subject suspected of being afflicted with at least one autism spectrum disorder and the control microRNA is generated from a nucleic acid sample isolated from a healthy individual; (b) preparing one or more microarrays comprising a plurality of different oligonucleotides having specificity for microRNAs associated with the at least one autism spectrum disorder; (c) applying the prepared samples to the one or more microarrays to allow hybridization between the oligonucleotides and the control microRNA and the oligonucleotide and the experimental microRNAs; (d) identifying the oligonucleotides on the microarray that display differential hybridization to the experimental microRNA relative to the control microRNA thereby determining a microRNA profile for the at least one autism spectrum disorder.

11. A method according to claim 10, wherein the plurality of different oligonucleotides is specific for at least five different microRNAs set out in Table 1, Table 2, or a combination thereof.

12. The method of claim 10, wherein the at least one autism spectrum disorder comprises autistic disorder, pervasive developmental disorder-not otherwise specified (POD-NOS), including atypical autism, Asperger's Disorder, or a combination thereof.

12. (canceled)

13.-35. (canceled)
